(19) United States
(12) Patent Application Publication
(10) Pub. No.: US 2014/0156735 A1
(43) Pub. Date: Jun. 5, 2014

(54) DISTRIBUTED PROCESSING METHOD AND INFORMATION PROCESSING APPARATUS

(71) Applicant: FUJITSU LIMITED, Kawasaki-shi (JP)

(72) Inventors: Koichi YAMASAKI, Kawasaki (JP); Kazuki MATSUI, Kawasaki (JP)

(73) Assignee: FUJITSU LIMITED, Kawasaki-shi (JP)

(21) Appl. No.: 14/047,112

(22) Filed: Oct. 7, 2013

(30) Foreign Application Priority Data
Nov. 30, 2012 (JP) 2012-262501

(51) Int. Cl. H04L 29/08; H04L 12/801

(52) U.S. Cl. CPC H04L 67/10; H04L 47/10
USPC 709/203

(57) ABSTRACT

A distributed processing method is provided for execution in a system formed from first and second information processing apparatus. The first information processing apparatus requests the second information processing apparatus to execute a processing operation off-loaded from the first information processing apparatus, while the first information processing apparatus is capable of executing the processing operation. It is then determined whether the amount of elapsed time since the request exceeds a threshold before an execution result of the processing operation is obtained from the second information processing apparatus. When the elapsed time is determined to have exceeded the threshold, the first information processing apparatus starts to locally execute the processing operation. The first information processing apparatus uses its local execution result or the execution result obtained from the second information processing apparatus, whichever comes earlier.

### CROSS-REFERENCE TO RELATED APPLICATION

This application is based upon and claims the benefit of priority of the prior Japanese Patent Application No. 2012-262501, filed on Nov. 30, 2012, the entire contents of which are incorporated herein by reference.

### FIELD

The embodiments discussed herein relate to a distributed processing method and an information processing apparatus.

### BACKGROUND

Recent years have seen an increasing use of cloud computing to prevent information leakage and reduce the cost of introduction, operation and management of information services. A cloud computing system performs data processing with networked servers or server clusters having high-performance central processing units (CPU). Linkage to such a cloud computing system enables personal computers, smart phone, and other popular electronic devices to execute some type of application software faster than executing it all by themselves.

Generally, embedded systems in mobile phones and digital cameras are relatively slower in processing speed, besides being limited in the functions that can be integrated. Those electronic devices may be designed to work with a cloud computing system in a coordinated way for enhancement of their processing speeds and functions. Think of, for example, a digital still camera that offers the function of recognizing some objects in a still image that is photographed with the device. The object recognition process may take a long time and consume a large amount of battery power if it is performed by the digital still camera alone. One solution for this issue may be to delegate all or some of the image processing tasks to a cloud computing system, so as to achieve faster processing and lower battery consumption.

Such systems may be implemented with a server-client model, where clients are connected to a server via a network, so that they can request processing services to the server when a need arises. The clients, however, do not always receive the processing result, because the network could fail, or the server could encounter some error in the middle of execution of application software. Several mechanisms have therefore been proposed to increase the fault tolerance of server-client systems.

For example, one proposed computer system includes a plurality of computing nodes under the control of a managing node. The managing node controls parallel execution of computational programs on the plurality of computing nodes. For enhanced fault tolerance, the computing nodes in this system are configured to have different hardware environments, software environments, peripheral device environments, and program launching environments. While some bug could hide in those computational programs, the proposed system configuration prevents the bug from coming to the surface in all the computing nodes at the same time, thereby increasing the system's tolerance to such bugs.

In an aspect related to high-speed computing of time-series data, there have been proposed an information processing system formed from a server node and a plurality of client nodes that manipulate a plurality of segments of data into which given time-series data is divided. In this information processing system, the given time-series data is divided in such a way that the resulting segments will include some part of the original time-series data in an overlapping manner. The client nodes work in parallel to execute estimation operations on the plurality of segments of data. The server node collects the execution result from each client node and forms them into a set of output time-series data.

For the background art, see, for example, the following documents:
Japanese Laid-open Patent Publication No. 2004-295738;
Japanese Laid-open Patent Publication No. 2006-252394.

As discussed above, one information processing apparatus (e.g., a client with a relatively low processing speed) may be configured to delegate some of its processing tasks to another information processing apparatus (e.g., a server with a relatively high processing speed) in expectation that the latter apparatus will be able to provide the result faster than the former apparatus. In most cases, the requested information processing apparatus provides its execution result as quickly as expected by the requesting information processing apparatus.

It is noted, however, that the requested information processing apparatus may happen to be in a highly loaded state at the moment when a request for some processing operations arrives. It is also possible that the network to which the information processing apparatus belongs may be experiencing congestion of data traffic at that moment. This means that the requesting information processing apparatus does not always receive the processing result within an expected time. Rather, there is always a risk of considerable delay in the response.

### SUMMARY

According to an aspect of the embodiments to be discussed later, there is provided a distributed processing method executed in a system formed from a first information processing apparatus and a second information processing apparatus. This distributed processing method includes the following operations: requesting, by a processor in the first information processing apparatus, the second information processing apparatus to execute a processing operation off-loaded from the first information processing apparatus, while the first information processing apparatus is capable of executing the processing operation; determining, by the processor, whether an amount of elapsed time since the requesting exceeds a threshold before an execution result of the processing operation is obtained from the second information processing apparatus; starting, by the processor, to locally execute the processing operation in the first information processing apparatus when the amount of elapsed time is determined to have exceeded the threshold; and using a local execution result of the processing operation executed in the first information processing apparatus or the execution result obtained from the second information processing apparatus, whichever comes earlier.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to a first embodiment;

FIG. 2 explains cloud-assisted processing functions;

FIG. 3 illustrates an example of an information processing system according to a second embodiment;

FIG. 4 illustrates an exemplary hardware configuration of a terminal device according to the second embodiment;

FIG. 5 is a block diagram illustrating an example of functions implemented in a terminal device according to the second embodiment;

FIG. 6 is a block diagram illustrating an example of functions implemented in a server device according to the second embodiment;

FIG. 7 illustrates an example of augmented execution according to the second embodiment;

FIG. 8 illustrates an example of data stored in a processing time storage unit of the terminal device according to the second embodiment;

FIG. 9 illustrates an example of data stored in a processing time storage unit of the server device according to the second embodiment;

FIG. 10 explains a method of estimating server processing times according to the second embodiment;

FIG. 11 illustrates an example of statistical records stored in a processing time storage unit of the server device according to the second embodiment;

FIGS. 12A and 12B illustrate an example of probing packets used in a proposed method for determining the network condition according to the second embodiment;

FIG. 13 illustrates a variation of the augmented execution according to the second embodiment;

FIG. 14 is a first diagram illustrating a variation of how the second embodiment may deal with a problem encountered during augmented execution in the server device;

FIG. 15 is a second diagram illustrating a variation of how the second embodiment may deal with a problem encountered during augmented execution in the server device;

FIGS. 16 and 17 are first and second diagrams illustrating an example of how the terminal device and server device work together according to the second embodiment;

FIGS. 18 to 20 are first to third diagrams illustrating an example of how an execution management unit works in the terminal device according to the second embodiment;

FIGS. 21 and 22 are first and second diagrams illustrating an example of how a terminal-side augmented execution unit works in the terminal device according to the second embodiment;

FIG. 23 illustrates an example of how a server processing time estimation unit works in the terminal device according to the second embodiment;

FIG. 24 illustrates an example of how a terminal processing time measurement unit works in the terminal device according to the second embodiment;

FIG. 25 illustrates an example of how a server-side augmented execution unit works in the server device according to the second embodiment; and

FIG. 26 illustrates an example of how a server processing time management unit works in the server device according to the second embodiment.

### DESCRIPTION OF EMBODIMENTS

Several embodiments will be described below with reference to the accompanying drawings.

### I. First Embodiment

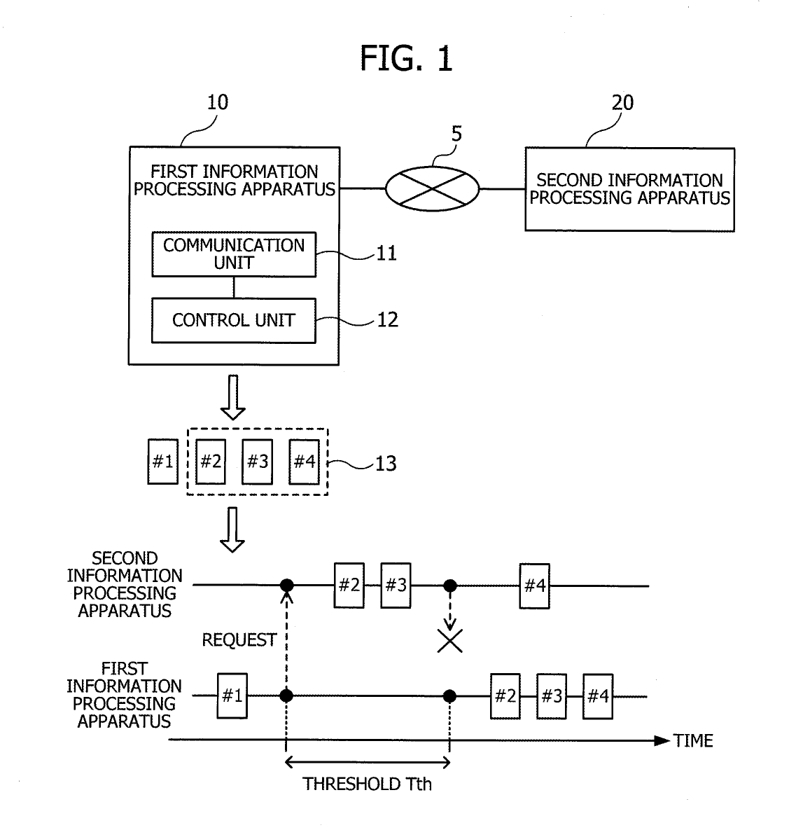

This section describes a first embodiment. FIG. 1 illustrates an example of an information processing apparatus according to the first embodiment. The illustrated system includes a first information processing apparatus 10 capable of communicating with a second information processing apparatus 20. For example, the first information processing apparatus 10 communicates with the second information processing apparatus 20 via a network 5. The network 5 may be a wired communications network, or may be a radio communications network. The second information processing apparatus 20 may be a single information processing apparatus, or may be an information processing system including a plurality of information processing apparatuses connected with one another. A cloud computing system is an example of the latter case.

The first information processing apparatus 10 includes a communication unit 11 and a control unit 12. While not depicted, the first information processing apparatus 10 may further include volatile storage devices such as random access memory (RAM), or non-volatile storage devices such as hard disk drive (HDD) and flash memory, or both types of storage devices.

The functions of the communication unit 11 and control unit 12 described below may be implemented with one or more processors such as central processing unit (CPU) or digital signal processor (DSP) or their combination. Other examples of processors for the communication unit 11 and control unit 12 include application-specific integrated circuit (ASIC), field-programmable gate array (FPGA), and similar electronics circuits. The communication unit 11 and control unit 12 execute programs stored in, for example, the volatile or non-volatile storage devices mentioned above.

The communication unit 11 requests the second information processing apparatus 20 to execute a processing operation 13 off-loaded from the first information processing apparatus 10, and receives an execution result of the processing operation 13 from the second information processing apparatus 20. That is, the processing operation 13 is delegated to the second information processing apparatus 20, while the first information processing apparatus 10 is capable of executing it.

Suppose, for example, the first information processing apparatus 10 has a specific application program (or simply “application”) to execute. The first information processing apparatus 10 requests the second information processing apparatus 20 to execute some of the constituent processing operations of the application (e.g., #2 to #4 in FIG. 1) as a single processing operation 13 (or a single set of processing operations). Suppose, for example, that the first information processing apparatus 10 has to perform face recognition and upconversion on a given image data. In this case, the first information processing apparatus 10 may delegate those load-intensive operations of face recognition and upconversion to the second information processing apparatus 20. By so doing, the first information processing apparatus 10 reduces its own load.

The control unit 12 determines whether the amount of elapsed time since the above request exceeds a threshold Tth before an execution result of the processing operation 13 is obtained from the second information processing apparatus 20. Threshold Tth may be chosen from, for example, a past record of an execution time measured when the second information processing apparatus 20 performed the processing operation 13. The control unit 12 starts to locally execute the processing operation 13 in the first information processing apparatus 10 when the amount of elapsed time is determined to have exceeded the threshold Tth. The control unit 12 uses this local execution result of the processing operation 13 executed by the first information processing apparatus 10 or a remote execution result obtained from the second information processing apparatus 20, whichever comes earlier.

As can be seen from the above, the first information processing apparatus 10 starts to execute the processing operation 13 by itself when the threshold Tth is reached. The first information processing apparatus 10 may possibly obtain the result in a shorter time in the case where the execution in the second information processing apparatus 20 is delayed considerably for some reasons. When the second information processing apparatus 20 comes back later with its execution result, and if that is before the execution is completed in the first information processing apparatus 10, the first information processing apparatus 10 is allowed to skip its current execution and proceed to other processing operations subsequent to the processing operation 13. The first embodiment alleviates in this way the risk of considerable delay of execution result.

The first embodiment has been discussed above. The next section will describe a second embodiment to provide more details.

### II. Second Embodiment

This section describes a second embodiment. The description begins with an example of cloud-assisted processing functions, which provide an electronic appliance with high processing speeds or expanded capabilities by incorporating service of a cloud computing system. Examples of such electronic appliances with cloud-assisted processing functions include digital still cameras, digital camcorders, cellular phones, smart phones, tablet computers, laptop computers, and automotive navigation systems. It is noted that the above functions may be embodied, not only with a cloud computing system, but also with other type of computing systems formed from one or more computers.

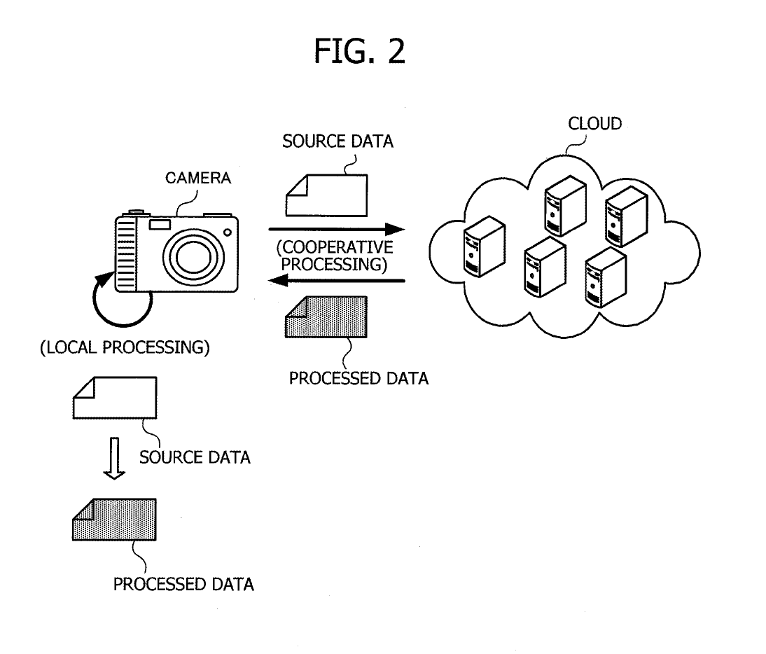

FIG. 2 explains cloud-assisted processing functions by way of example. In this particular example of FIG. 2, a digital still camera is configured to work with a cloud computing system. Ordinary digital still cameras have a lower performance than cloud computing systems in terms of data processing. A digital still camera will be able to execute its processing at a higher speed if it is configured to use the service of a cloud computing system. This approach also contributes to a smaller battery power consumption in the digital still camera because the use of a cloud computing system reduces the amount of data processing that the camera has to perform.

Cloud computing systems may provide functions that are not available in digital still cameras. Those functions include sophisticated image processing functions (e.g., advanced object recognition, complex picture effects, enhanced resolution upconversion) that are not supported by ordinary digital still cameras. Linkage to a cloud computing system makes it possible to add such advanced functions to a digital still camera.

Cloud-assisted processing functions are performed in the way depicted in FIG. 2. In the first place, the digital still camera sends source data (raw data to be processed) to the cloud computing system. The cloud computing system executes requested operations on the received source data and sends the resulting processed data back to the digital still camera. The digital still camera then uses the processed data received from the cloud computing system. This method permits the user to execute advanced image processing, such as developing a raw image, by using a cloud computing system.

The speed of processing actually depends on what is performed with the cloud computing system. In some cases, a digital still camera may be responsive enough without using cloud-assisted processing functions. For example, some class of processing operations are so light-loaded that they are finished in a shorter time than the time it would take to transmit and receive data associated with them. It is therefore advantages for a digital still camera to execute these processing operations locally. As another example, the execution of a processing operation in a cloud computing system could be delayed seriously by increased load of the system itself or increased traffic of the network. In this situation, it is more likely that the local execution by a digital still camera can yield the processing result more quickly.

In view of the above-described situations in which the cloud-assisted processing functions are used, the second embodiment provides an improved cooperative processing method for a terminal device and a server device to work together. The proposed method permits the terminal device to quickly start execution of processing operations even if the server device stalls during the execution of requested tasks. Note that the following sections will use the term “augmented execution” to refer to the way of server execution of processing operations delegated from a terminal device.

### (A) INFORMATION PROCESSING SYSTEM

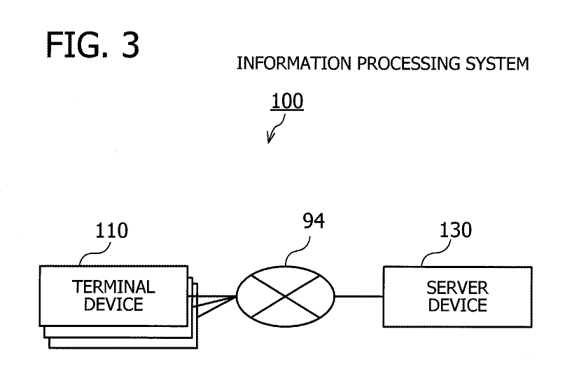

FIG. 3 illustrates an example of an information processing system according to the second embodiment. The illustrated information processing system 100 of the second embodiment includes a plurality of terminal devices 110 and a server device 130, connected together via a network 94. FIG. 3 illustrates only one server device 130, but the information processing system 100 may include two or more such server devices 130. For simplicity, this description assumes a single server device 130. While not depicted in FIG. 3, the information processing system 100 may further include storage devices connected to the server device 130 directly or via the network 94.

The server device 130 is an example of an information processing apparatus. The functions of the server device 130 may be implemented on one or more computers with a higher performance and a larger storage capacity, relative to the terminal device 110. These computers may be organized as a cloud computing system such as the one discussed in previous sections. The functions of the server device 130 may also be implemented as a combination of computers and storage systems.

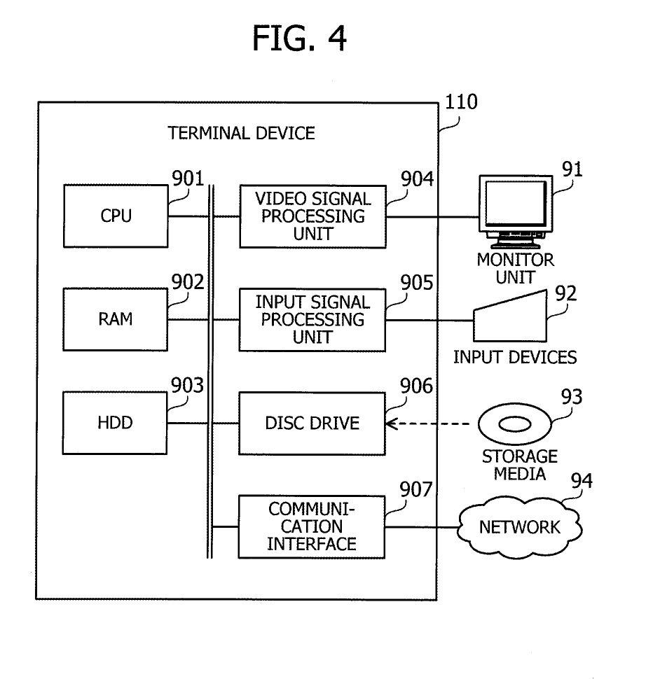

The terminal device 110 is another example of an information processing apparatus. The functions of this terminal device 110 may be implemented in various ways. For example, the communication unit 11 may be an electronic appliance with the foregoing cloud-assisted processing functions, with a hardware configuration discussed below in FIG. 4.

### (B) TERMINAL DEVICE HARDWARE

FIG. 4 illustrates an exemplary hardware configuration of a terminal device according to the second embodiment. The illustrated terminal device 110 of FIG. 4 includes a CPU 901, a RAM 902, an HDD 903, a video signal processing unit 904, an input signal processing unit 905, a disc drive 906, and a communication interface 907. While not depicted in FIG. 4, an image sensing component, such as charge-coupled device (CCD) sensor or complementary metal oxide semiconductor (CMOS) sensor, may also be included in the terminal device 110. When this is the case, the terminal device 110 may further include a signal processing circuit (not illustrated) to process image signals produced by the image sensing component.

The CPU 901 in FIG. 4 is an example of the communication unit 11 and control unit 12 discussed in the first embodiment. The communication interface 907 is used to implement the functions of the communication unit 11 discussed in the first embodiment.

The CPU 901 is a processor containing arithmetic and logic units and other computational units to execute programmed instructions. The CPU 901 loads the RAM 902 with at least part of programs and data read out of the HDD 903 and executes instructions in those programs. The CPU 901 may include a plurality of processor cores. The terminal device 110 may include two or more such CPUs 901 to execute a plurality of processing operations in parallel.

The RAM 102 is a volatile memory device serving as temporary storage for programs that the CPU 101 executes, as well as for various data that the CPU 101 uses to execute the programs. The terminal device 110 may, however, have other kind of memory devices, rather than the RAM 902. Also, the terminal device 110 may have two or more sets of such memory devices.

The HDD 903 is an example of non-volatile storage devices used to store program files of the operating system (OS), firmware, application software, and the like, together with data files used in processing operations. The terminal device 110 may have other storage devices such as flash memory and solid state drives (SSD) in place of or together with the HDD 903. Also, the terminal device 110 may include two or more sets of such storage devices.

The video signal processing unit 904 produces video signals under the control of the CPU 901 and outputs them to a monitor unit 91 attached to the terminal device 110. The monitor unit 91 may be, for example, a cathode ray tube (CRT) display, liquid crystal display (LCD), plasma display panel (PDP), organic electro-luminescence display device (GELD), or other display device. The monitor unit 91 may be integrated as part of the terminal device 110.

The input signal processing unit 905 receives input signals from input devices 92 attached to the terminal device 110 and supplies them to the CPU 901. The input devices 92 may be a mouse, keyboard, touchscreen, touchpad, trackball, remote controller, buttons, or the like. Such input devices 92 may be integrated as part of the terminal device 110.

The disc drive 906 is a device used to read programs and data stored in storage media 93. The storage media 93 include, for example, magnetic disk media such as flexible disk (FD) and HDD, optical disc media such as compact disc (CD) and digital versatile disc (DVD), and magneto-optical storage media such as magneto-optical disk (MO). The disc drive 906 may be replaced with a reader for semiconductor memory devices that serve as still another type of storage media 93. Under the control of the CPU 901, the disc drive 906 transfers programs and data read out of such storage media 93 to the RAM 902 or HDD 903.

The communication interface 907 is an interface for the CPU 901 to communicate with other computers via a network 94. For example, the communication interface 907 may be a wired interface or a radio interface for connection with a local area network (LAN) or a wide area network (WAN) such as the Internet.

The server device 130 may be implemented on a hardware platform similar to the one discussed in FIG. 4 for the terminal device 110. It is preferable, however, that the server device 130 has a CPU with a higher performance than the CPU 901 of the terminal device 110. It is also preferable for the server device 130 to include RAM and HDD with a larger data capacity than the RAM 902 and HDD 903 of the terminal device 110. The server device 130 may be implemented as a computing system formed from a plurality of computers that have a hardware configuration of FIG. 4 and are interconnected by a network 94.

### (C) TERMINAL DEVICE

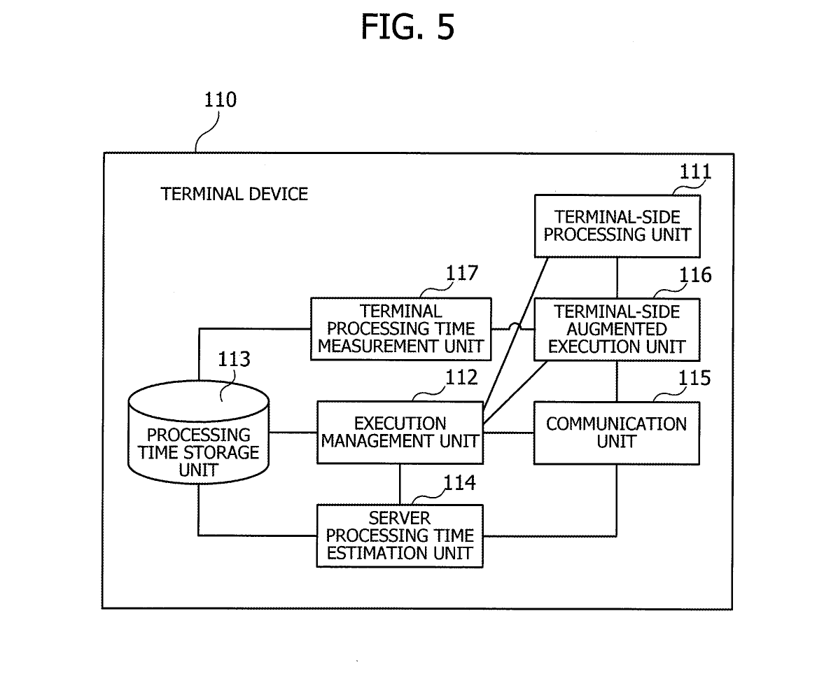

FIG. 5 is a block diagram illustrating an example of functions implemented in a terminal device according to the second embodiment. The illustrated terminal device 110 of FIG. 5 includes a terminal-side processing unit 111, an execution management unit 112, a processing time storage unit 113, a server processing time estimation unit 114, a communication unit 115, a terminal-side augmented execution unit 116, and a terminal processing time measurement unit 117.

For example, the terminal-side processing unit 111, execution management unit 112, server processing time estimation unit 114, terminal-side augmented execution unit 116, terminal processing time measurement unit 117 may be implemented as program modules executed by the CPU 901. It is also possible to use electronic circuits, rather than software, to implement all or part of the functions of the terminal-side processing unit 111, execution management unit 112, server processing time estimation unit 114, terminal-side augmented execution unit 116, and terminal processing time measurement unit 117. The processing time storage unit 113 may be a storage space allocated from the RAM 902 or HDD 903. The foregoing communication interface 907 may provide functions of the communication unit 115.

i) Terminal-Side Processing Unit 111

The terminal-side processing unit 111 executes applications. For example, the terminal-side processing unit 111 executes one or more predetermined applications upon startup of the terminal device 110. The terminal-side processing unit 111 also executes a particular application when it is specified by the user. For example, the terminal-side processing unit 111 executes applications for creating or playing multimedia content including voice data, image data, and text data.

More specifically, the RAM 902 and HDD 903 store parameters and executive code of various applications. The terminal-side processing unit 111 executes a specific application by using its corresponding parameters and executive code read out of the RAM 902 and HDD 903. The executive code may be a binary code previously compiled, or may be a code written in a scripting language.

As will be described later, the execution management unit 112 or terminal-side augmented execution unit 116 may issue a command for stopping execution of an application. When this stop command is received, the terminal-side processing unit 111 outputs state data including parameter values stored in the RAM 902 and HDD 903 to save the state of the application that has been executed up to that point. The state data will be used to resume the application from the point at which it was stopped.

When the terminal device 110 executes, for example, a Java (registered trademark) application, several memory areas called “stack” and “heap” are allocated in its RAM 902 or HDD 903. The stack area stores local variables used for temporary reference, as well as pointers (addresses) that indicate up to which instruction the application was executed. The heap area stores data that was generated dynamically. Such data in the stack area and heap area is an example of the state data noted above.

ii) Execution Management Unit 112

The execution management unit 112 controls operation of the terminal-side processing unit 111. For example, the execution management unit 112 causes the terminal-side processing unit 111 to execute a predetermined application upon startup of the terminal device 110. The execution management unit 112 also causes the terminal-side processing unit 111 to execute a particular application when it is specified by the user. The execution management unit 112 similarly causes the terminal-side processing unit 111 to stop an ongoing application when so commanded by the user.

The execution management unit 112 also controls operation of the terminal-side augmented execution unit 116. For example, the execution management unit 112 causes the terminal-side augmented execution unit 116 to start augmented execution (described later) when: (a) it has previously been commanded to do so, or (b) a certain condition is met in the processing operations or in the execution environment. The former condition (a) is, for example, when the application of interest is configured to use the feature of augmented execution to execute a particular processing operation. As a more specific example, an image processing application may be configured to use augmented execution for an upconversion operation that increases the resolution of a given image. In this case, the execution management unit 112 causes the terminal-side augmented execution unit 116 to initiate augmented execution when an upconversion operation is called. Generally, an application program includes a series of processing operations, which may be divided into “sections” each being one or more processing operations to be executed in succession.

Application programs may have a particular section that is previously designated as being suitable for augmented execution. Such sections are referred to herein as “augmentable sections.” When an augmentable section is reached during the execution of an application, the execution management unit 112 commands the terminal-side augmented execution unit 116 to start augmented execution of that section. Here the execution management unit 112 may be configured to determine whether the augmented execution is expected to work effectively, before issuing a command of augmented execution to the terminal-side augmented execution unit 116. When this determination returns a positive result, the execution management unit 112 initiates augmented execution.

Augmented execution is an enhanced way for the terminal device 110 to execute an application in cooperation with the server device 130. More specifically, the terminal device 110 asks the server device 130 to execute a specific part of the application, thus taking advantage of higher performance of the server device 130. Augmented execution makes it more likely for the application to finish in a shorter time, compared with the case in which all the processing operations are executed by the terminal device 110 alone. The effect of augmented execution may, however, be limited by the server load and network condition. Taking this into consideration, the execution management unit 112 confirms that the augmented execution works as effectively as expected, before triggering the terminal-side augmented execution unit 116 to start it.

For example, the execution management unit 112 checks the current network condition between the terminal device 110 and server device 130, as well as the current load condition of the server device 130. The execution management unit 112 further estimates the time that the server device 130 is expected to spend to execute processing operations in an augmentable section of the application, assuming that those processing operations are delegated to the server device 130 under the current network and load condition. This time is referred to herein as the “server processing time.” For example, the server processing time of a specific application is obtained from past data of processing times measured for the same application. The execution management unit 112 uses such past measurement records to provide a current estimate of the server processing time in question. The details of how to estimate server processing times will be described later.

The execution management unit 112 compares the estimated server processing time with a predetermined threshold. The threshold may be, for example, an estimated time that the terminal device 110 would need for the augmentable section of the application, if all the processing operations in that section are executed by the terminal device 110 alone. This processing time is referred to herein as the “terminal processing time.” Estimation of a terminal processing time for a specific application may be based on the past data of processing times measured at the terminal device 110 for the same application. As an alternative to the above, the threshold may be specified previously by the user.

When the server processing time is smaller than the threshold (i.e., augmented execution is expected to work effectively), the execution management unit 112 triggers the terminal-side augmented execution unit 116 to start augmented execution. When, on the other hand, the server processing time is greater than or equal to the threshold (i.e., augmented execution may be ineffective), the execution management unit 112 lets the terminal-side processing unit 111 to continue its processing, including the processing operations in the augmentable section.

After triggering the terminal-side augmented execution unit 116 to start augmented execution, the execution management unit 112 waits for a response from the server device 130 until the above-noted server process time is reached. What the execution management unit 112 is expecting to receive is a set of state data representing the result of processing operations in the augmentable section executed by the server device 130. When such state data is received, the execution management unit 112 informs the terminal-side augmented execution unit 116 that the augmented execution is finished. The execution management unit 112 then causes the terminal-side processing unit 111 to execute the remaining processing operations (i.e., those subsequent to the augmentable section) by using the received state data. When, on the other hand, the server processing time has expired without receiving state data from the server device 130, the execution management unit 112 commands the terminal-side processing unit 111 to resume the execution, including processing operations in the augmentable section.

As seen from the above description, the execution management unit 112 is designed to determine whether to make the terminal-side processing unit 111 execute processing operations in an augmentable section, depending on the passage of the server processing time. This feature of the execution management unit 112 makes it possible for the terminal device 110 to self-start execution of the augmentable section in the case where the server device 130 is unable to finish the section for some reasons.

Even if the server processing time expires, it is still possible for the terminal device 110 to receive state data from the server device 130 some time later. When this happens before the terminal-side processing unit 111 finishes its execution of a given augmentable section, the execution management unit 112 commands the terminal-side processing unit 111 to stop the ongoing execution of the augmentable section and informs the terminal-side augmented execution unit 116 of completion of the augmented execution. The execution management unit 112 then causes the terminal-side processing unit 111 to execute the remaining processing operations (i.e., those subsequent to the augmentable section) by using the state data received from the server device 130. That is, even in the case where it has already started local execution of the augmentable section, the terminal device 110 uses state data from the server device 130 if it comes earlier than its own one.

When there is a considerable processing delay on the server part, the terminal-side processing unit 111 may finish the augmentable section earlier than the server device 130. In this case, the execution management unit 112 permits the terminal-side processing unit 111 to move forward and execute the rest of the application, while informing the terminal-side augmented execution unit 116 that the augmented execution is finished. The execution management unit 112 is to discard state data from the server device 130 when it is received. The processing operations are continued in this way by the terminal-side processing unit 111 when it has finished the augmentable section earlier than the processing time storage unit 113.

iii) Processing Time Storage Unit 113

The processing time storage unit 113 provides a storage space for recording terminal processing times. Specifically, the processing time storage unit 113 stores measurement records of terminal processing times obtained at the time of execution of applications by the terminal-side processing unit 111. For example, the measurements of terminal processing times are stored application by application, optionally together with some additional information indicating the load condition of the terminal device 110 immediately before the pertinent application is executed by the terminal-side processing unit 111. The load condition may be expressed in terms of the average of CPU usage ratio observed during a predetermined time period after the start of processing. This value is referred to herein as the “average CPU usage.”

iv) Server Processing Time Estimation Unit 114

The server processing time estimation unit 114 estimates a server processing time of an application in process of execution, when the execution management unit 112 finds no past measurement records for that same application. This estimation of a server processing time may be based on the existing measurement records of some other applications executed in the past.

When estimating a server processing time, the server processing time estimation unit 114 may also take into consideration the load condition of the server device 130, as well as the condition of a network between the terminal device 110 and server device 130. The load condition may be observed as, for example, the average CPU usage mentioned above. The network condition, on the other hand, may be determined by measuring how long time it takes for a fixed amount of data transmitted from the terminal device 110 to reach the server device 130. This time is referred to herein as the “data transmission time.” Details of the server processing time estimation will be described later.

v) Communication Unit 115

The communication unit 115 provides the capability of communicating with the server device 130. For example, the communication unit 115 transmits and receives state data for use in the augmented execution discussed above. The communication unit 115 also receives information about server processing times, as well as terminal processing times of other terminal devices, from the server device 130. The communication unit 115 sends the server device 130 information about terminal processing times of the terminal device 110, which are measured by a terminal processing time measurement unit 117 described later.

To obtain the current condition of the network, the communication unit 115 sends the server device 130 a probing packet for measurement of a data transmission time. This probing packet contains a transmission time stamp indicating when the packet is transmitted. The communication unit 115 then receives a probing packet sent back from the server device 130. The received packet contains both transmission and reception time stamps, enabling calculation of the data transmission time in question. This exchange of probing packets is performed before the execution management unit 112 determines whether to use augmented execution.

vi) Terminal-Side Augmented Execution Unit 116

The terminal-side augmented execution unit 116 controls the terminal-side processing unit 111 when augmented execution is enabled. For example, the terminal-side augmented execution unit 116 may receive a command from the execution management unit 112 that initiates augmented execution of an augmentable section. In response to this command, the terminal-side augmented execution unit 116 causes the terminal-side processing unit 111 to stop its operation at the point immediately before the augmentable section begins. The execution management unit 112 then sends the server device 130 a set of state data that the terminal-side processing unit 111 has produced. The execution management unit 112 then receives state data sent back from the server device 130 as a result of the augmented execution. The execution management unit 112 now sends a resume command to the terminal-side augmented execution unit 116, which causes the terminal-side processing unit 111 to start executing the processing operations subsequent to the augmentable section.

When causing the terminal-side processing unit 111 to execute an augmentable section, the terminal-side augmented execution unit 116 requests the terminal processing time measurement unit 117 to measure the terminal processing time. For example, the terminal-side augmented execution unit 116 triggers the terminal processing time measurement unit 117 to start counting the time when the terminal-side processing unit 111 begins execution of the augmentable section. Upon completion of the execution by the terminal-side processing unit 111, the terminal-side augmented execution unit 116 causes the terminal processing time measurement unit 117 to stop counting the terminal processing time.

The execution management unit 112 may issue a command to stop the terminal-side processing unit 111 in the middle of its processing of an augmentable section. When this command is received, the terminal-side augmented execution unit 116 makes the terminal processing time measurement unit 117 quit counting the terminal processing time, besides causing the terminal-side processing unit 111 to stop its processing of the augmentable section.

vii) Terminal Processing Time Measurement Unit 117

The terminal processing time measurement unit 117 measures terminal processing times. For example, the terminal processing time measurement unit 117 starts counting the time when so commanded by the terminal-side augmented execution unit 116. The terminal processing time measurement unit 117 stops counting the time when so commanded by the terminal-side augmented execution unit 116. The elapsed time between the starting and stopping points is then output as a measurement of the terminal processing time. The terminal processing time measurement unit 117 adds a record of this terminal processing time in the processing time storage unit 113.

The terminal processing time measurement unit 117 enters such records of terminal processing times in the processing time storage unit 113, together with some additional information that associates them with the applications that the terminal-side processing unit 111 executed. The additional information may further associate the terminal processing times with the load condition of the terminal device 110 if such data is available. The terminal processing time measurement unit 117 sends the records of terminal processing times to the server device 130, including optional information on the load condition.

The above section has described the functions implemented in the proposed terminal device 110. The next section will now describe those in the server device 130.

### (D) SERVER DEVICE

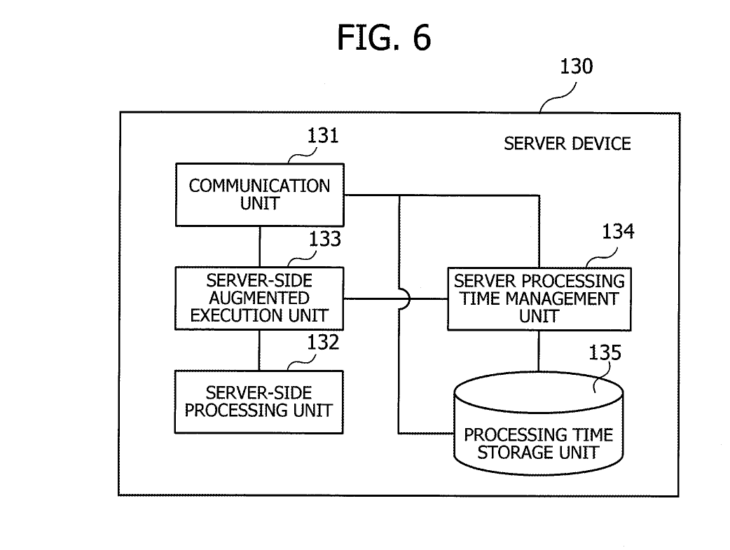

FIG. 6 is a block diagram illustrating an example of functions implemented in a server device according to the second embodiment. The illustrated server device 130 of FIG. 6 includes a communication unit 131, a server-side processing unit 132, a server-side augmented execution unit 133, a server processing time management unit 134, and a processing time storage unit 135.

The server-side processing unit 132, server-side augmented execution unit 133, server processing time management unit 134 may be implemented as program modules executed by the CPU 901, when the foregoing hardware configuration of FIG. 4 is applied to the server device 130. It is also possible to use electronic circuits, rather than software, to implement all or part of the functions of the server-side processing unit 132, server-side augmented execution unit 133, and server processing time management unit 134. The foregoing communication interface 907 of FIG. 4 may serve as the communication unit 131. The processing time storage unit 135 may be a storage space allocated from the RAM 902 or HDD 903.

i) Communication Unit 131

The communication unit 131 provides the capability of communicating with the terminal device 110. For example, the communication unit 131 transmits and receive state data for use in the augmented execution discussed above. The communication unit 131 receives a probing packet that the terminal device 110 sends for measurement of a data transmission time. This probing packet contains a transmission time stamp indicating when the packet was transmitted. In response, the communication unit 131 sends a probing packet back to the terminal device 110, which contains both the transmission and reception time stamps for calculation of the data transmission time in question.

The communication unit 131 transmits some of the stored records in the processing time storage unit 135 to the terminal device 110 for their use in augmented execution. These records may include information about server processing times of the server device 130, as well as terminal processing times of other terminal devices than the terminal device 110. For example, the server device 130 receives a request from the terminal device 110 for information about server processing times. In response, the communication unit 131 transmits the requested information read out of the processing time storage unit 135. The communication unit 131 may also receive information about terminal processing times of the terminal device 110, which are measured by the terminal processing time measurement unit 117.

ii) Server-Side Processing Unit 132

The server-side processing unit 132 executes applications. For example, the server-side augmented execution unit 133 executes processing operations in the augmentable section of an application, using state data supplied from the terminal device 110. When the execution of the augmentable section is finished, the server-side processing unit 132 outputs a set of state data including parameter values stored in the RAM 902 and HDD 903 (e.g., those stored in stack areas and heap areas). This state data will be used by the terminal device 110 to execute remaining processing operations subsequent to the augmentable section.

iii) Server-Side Augmented Execution Unit 133

The server-side augmented execution unit 133 causes the server-side processing unit 132 to execute processing operations in an augmentable section. For example, the server-side augmented execution unit 133 provides the server-side processing unit 132 with state data received from the terminal device 110 and makes the server-side processing unit 132 execute the augmentable section with that state data.

The server-side augmented execution unit 133 causes the server processing time management unit 134 to measure server processing times. For example, the server-side augmented execution unit 133 triggers the server processing time management unit 134 to start counting the time when the server-side processing unit 132 begins execution of an augmentable section. Then upon completion of the execution by the server-side processing unit 132, the server-side augmented execution unit 133 causes the server processing time management unit 134 to stop counting the time.

The server-side augmented execution unit 133 checks the load condition of the server device 130 immediately before the server-side processing unit 132 starts processing an augmentable section. For example, the load condition may be observed as the average CPU usage of the server device 130. The server-side augmented execution unit 133 sends such load condition information to the terminal device 110. The server-side augmented execution unit 133 also sends the same to the server processing time management unit 134.

When the execution of the augmentable section is finished, the server-side processing unit 132 outputs its processing result as a set of state data. The server-side augmented execution unit 133 transmits this state data back to the terminal device 110.

iv) Server Processing Time Management Unit 134

The server processing time management unit 134 measures server processing times. For example, the server processing time management unit 134 starts counting the time when so commanded by the server-side augmented execution unit 133. The server processing time management unit 134 stops counting the time when so commanded by the server-side augmented execution unit 133. The elapsed time between the starting and stopping points is then output as a measurement of the server processing time. The server processing time management unit 134 adds a record of this server processing time in the processing time storage unit 135.

The server processing time management unit 134 enters such records of server processing times in the processing time storage unit 135. Each record describes a server processing time associated with a particular application that the server-side processing unit 132 executed. The record may further associate the server processing time with the load condition of the server device 130 when such data is available.

The server processing time management unit 134 may receive information indicating a terminal processing time from the terminal device 110. In this case, the server processing time management unit 134 produces a record in the processing time storage unit 135 to store the received information. Specifically, this record associates the received terminal processing time with a particular application executed by the terminal device 110, as well as with the identifier of the source terminal device 110. The record may further associate the terminal processing time with the load condition of the terminal device 110 when such data is available.

v) Processing Time Storage Unit 135

The processing time storage unit 135 provides a storage space for the records of server and terminal processing times. That is, the processing time storage unit 135 stores records of server processing times measured by the server processing time management unit 134, as well as those of terminal processing times received from the terminal device 110.

Those processing time records in the processing time storage unit 135 actually include several pieces of information, including the identifier of a server or terminal device, associated with the server or terminal processing times. For example, each server processing time record describes which application was executed by the server device 130 under what load condition and network condition. Similarly, each terminal processing time record indicates which application was executed by which terminal device 110 under what load condition and network condition.

Referring to the example seen in FIG. 6, the processing time storage unit 135 is an integral part of the server device 130. It is possible, however, to modify the illustrated configuration of the processing time storage unit 135. For example, the processing time storage unit 135 may also be implemented as an external storage device (not illustrated) attached to the server device 130, so that other components in the server device 130 make access to the stored records.

The above section has described the functions implemented in the proposed server device 130. The next section will now provide details of augmented execution.

### (E) AUGMENTED EXECUTION

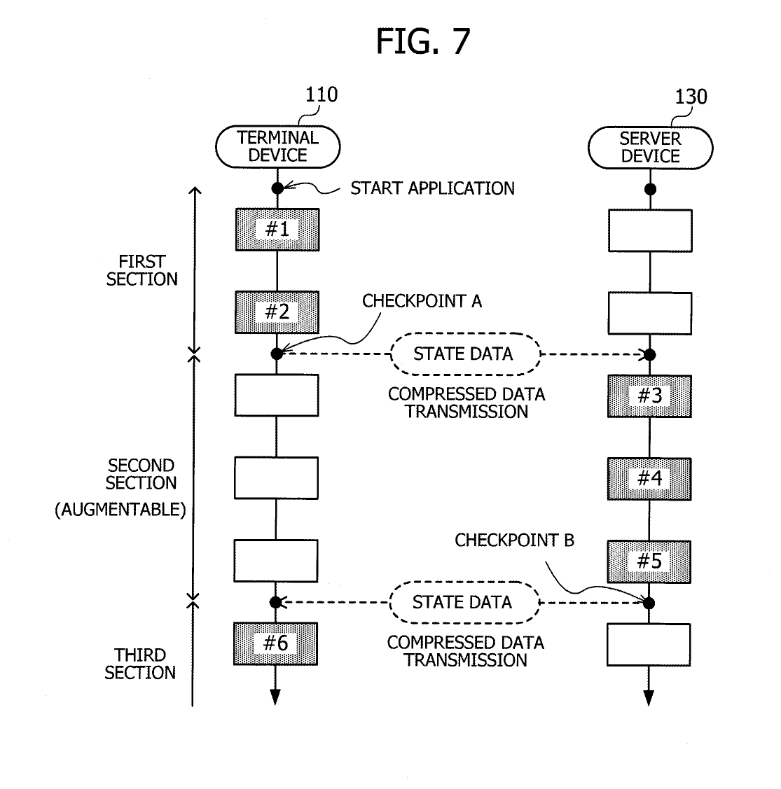

FIG. 7 illustrates an example of augmented execution according to the second embodiment. This example includes a time series of processing operations #1, #2, #3, #4, #5, #6, and so on. The first two processing operations #1 and #2 form a first section, and the next three processing operations #3 to #5 form a second section. The subsequent processing operations #6 and so on form a third section. The second section is an augmentable section. In the case of, for example, an image processing application, the first section decodes and displays a coded image, the second section executes face recognition, and the third section displays the result of the face recognition.

Referring to the example of FIG. 7, two checkpoints A and B have been defined previously. Checkpointing is a process or technique of taking a snapshot of state data in one of the devices involved in migration of a JAVA application environment. For example, the locations of checkpoints in a specific program may be specified in the program itself or in a configuration file accompanying the program. The terminal device 110 and server device 130 may have their respective configuration files describing where to place checkpoints.

The terminal device 110 executes the first two processing operations #1 and #2 and then saves the current data in its stack and heap areas as a set of state data at checkpoint A. The terminal device 110 further sends the server device 130 a compressed version of the stored state data.

Upon receipt of state data from the terminal device 110, the server device 130 launches the requested application, allocating some storage areas in the RAM 902 or HDD 903 or both for use as stack and heap areas. The server device 130 loads the stack and heap areas with the received state data and then begins execution of the second section with its first processing operation #3. Regarding the environment for the application, the server device 130 may change the mapping of memory address space. The server device 130 may prepare a set of executive code of applications in its own storage space, or may be configured to receive executive code, together with state data therefor, from the requesting terminal device 110.

Upon completion of all processing operations #3 to #5 in the second section, the server device 130 saves the current data in its stack and heap areas as a set of state data at checkpoint B. The server device 130 then sends the terminal device 110 a compressed version of the saved state data.

The terminal device 110 now overwrites its stack and heap areas with the state data received from the server device 130 and then begins execution of the third section with its first processing operation #6. Here the terminal device 110 may change the mapping of memory address space. As can be seen from the above, the server device 130 is configured to execute processing operations in an augmentable section by using specified state data and provide the resulting data back to the terminal device 110 in order to continue the remaining processing operations in the terminal device 110.

An example of augmented execution has been explained above. The next section will describe what information is stored in relation to terminal and server processing times.

### (F) DATA STORED IN TERMINAL AND SERVER DEVICES

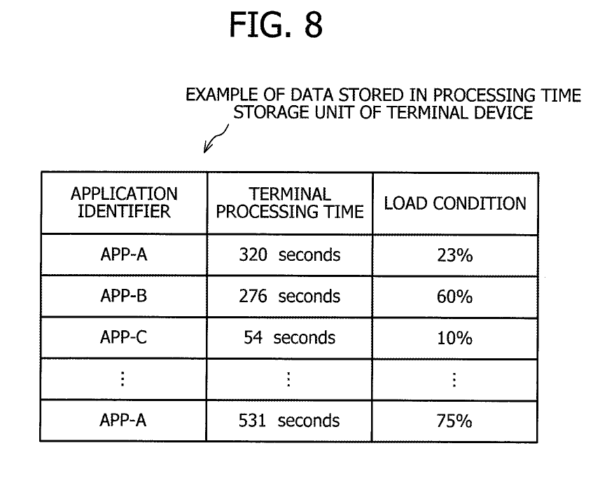

FIG. 8 illustrates an example of data stored in a processing time storage unit of a terminal device according to the second embodiment. The processing time storage unit 113 in the terminal device 110 stores information about terminal processing times. As seen in FIG. 8, each record of terminal processing time includes two pieces of related information. One is the application identifier indicating what application was executed, and the other is a value representing the load condition of the terminal device 110 immediately before the terminal processing time was measured.

For example, the first record seen in FIG. 8 contains two associated values of “APP-A” and “320 seconds.” This means that the terminal device 110 executed an application named “APP-A” in 320 seconds. These two values are accompanied by another associated value “23%” indicating the load condition of the terminal device 110 immediately before the execution of application APP-A was started. This value “23%” is an average CPU usage measured during a predetermined period before the execution.

Such terminal processing time records are stored for various applications and different load conditions, enabling the terminal device 110 to estimate how much time is needed to execute processing operations in a given augmentable section. For example, when executing a specific application, the terminal device 110 may be able to find a stored record of terminal processing time that corresponds to the application and is associated with a load condition value close to its own condition at the moment. Then the terminal device 110 expects that the given application will be finished in some amount of time equivalent to the terminal processing time seen in the record. The terminal processing time records stored in the processing time storage unit 113 may also be used to estimate server processing times as will be described later.

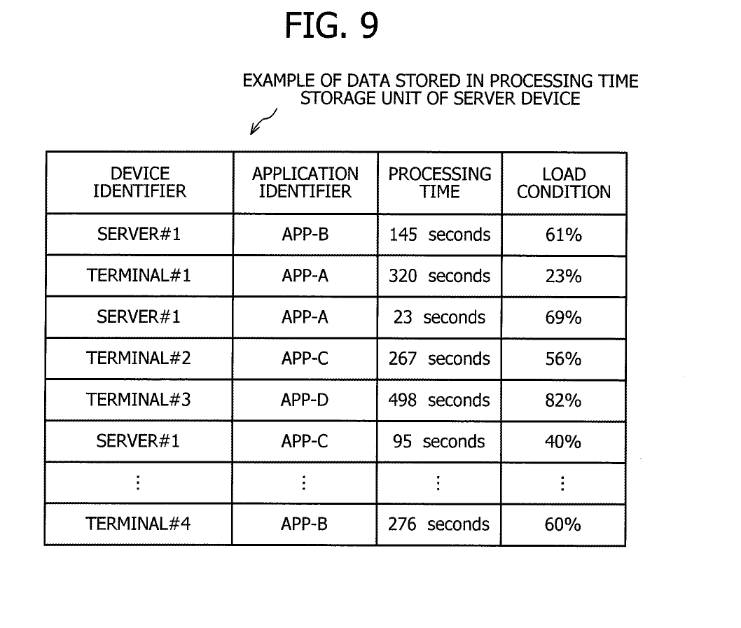

FIG. 9 illustrates an example of data stored in a processing time storage unit of the server device according to the second embodiment. The illustrated processing time storage unit 135 in the server device 130 stores a collection of records of terminal processing times and server processing times. Each record of terminal processing time is associated with the identifier of a specific terminal device (e.g., “TERMINAL#1” . . . in FIG. 9). Similarly, each record of server processing time is associated with the identifier of a specific server device (e.g., “SERVER#1” . . . in FIG. 9).

The processing time storage unit 135 stores two pieces of information relating to each terminal processing time. One is an application identifier indicating what application was executed, and the other is a value representing the load condition of the terminal device 110 immediately before the terminal processing time was measured. Similarly, the processing time storage unit 135 stores the following information for each server processing time: an application identifier indicating what application was executed, and a value representing the load condition of the server device 130 immediately before the server processing time was measured.

For example, the first record seen in FIG. 9 contains two associated values of “APP-B” and “145 seconds.” This means that the server device 130 executed an application named “APP-B” in 145 seconds. These two values are accompanied by another associated value “61%” indicating the load condition of the server device 130 immediately before the execution of application APP-B was started. This value “61%” is an average CPU usage measured during a predetermined period before the execution.

Such server processing time records are stored for various applications and different load conditions, enabling estimation of how much time is needed for the server device 130 to execute processing operations in a given augmentable section. For example, the server device 130 is expected to finish processing operations in an application in some amount of time equivalent to the server processing time seen in a stored record (if any) that corresponds to the application and is associated with a load condition close to the current condition of the server device 130. Those records stored in the processing time storage unit 135 can also be used to estimate a server processing time of other applications as will be described later.

As mentioned above, the processing time storage unit 135 also stores records of terminal processing time. For example, the second record seen in FIG. 9 contains two associated values of “APP-A” and “320 seconds.” This means that the terminal device 110 executed an application named “APP-A” in 320 seconds. These two values are accompanied by another associated value “23%” indicating the load condition of the terminal device 110 immediately before the execution of application APP-A was started. This value “23%” is an average CPU usage measured during a predetermined period before the execution. These records may be used to estimate server processing times as well.

The above section has described what is stored in terminal devices and server devices. While not depicted in the above-described example of FIG. 9, the records of server processing time stored in the processing time storage unit 135 may further include another piece of information (e.g., data transmission time) that indicates network condition.

### (G) ESTIMATION OF SERVER PROCESSING TIME

For augmented execution of an application, the terminal device 110 uses the records of server processing time measured when the server device 130 executed that application in the past. In the case where no such records are present for the application of interest, the terminal device 110 makes an estimation of the server processing time in the way described below.

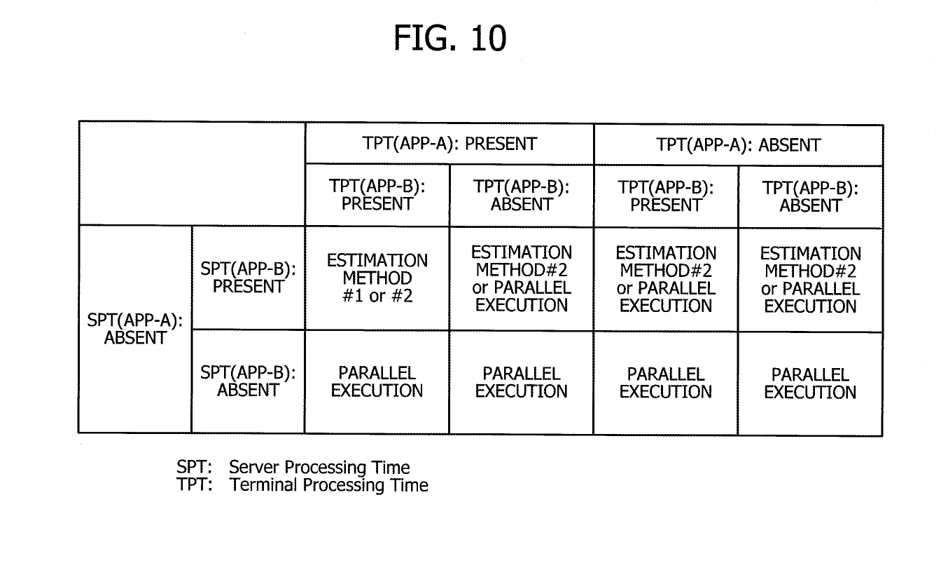

FIG. 10 explains a method of estimating server processing times according to the second embodiment. The following subsections will present two methods (estimation methods #1 and #2), assuming that the server device 130 is to execute some processing operations in an application named “APP-A.” As seen from FIG. 10, either of these estimation methods #1 and #2 is applied depending on the combination of several conditions.

i) Estimation Method #1

Estimation method #1 is to calculate a server processing time under the assumption that the ratio between server processing time and terminal processing time is fixed for all applications. For example, estimation method #1 may be used to estimate an unknown server processing time of application APP-A, when there are records indicating terminal processing times of APP-A and APP-B, and when there is also a record indicating a server processing time of APP-B. Because of the limitations of space, FIG. 10 depicts these conditions as “TPT(APP-A): PRESENT,” “TPT(APP-B): PRESENT,” and “SPT(APP-B): PRESENT,” where SPT denotes server processing time, and TPT denotes terminal processing time. APP-B is one of the applications different from APP-A.

Let T_{BT} represent a terminal processing time of APP-B, T_{BS} a server processing time of APP-B, and T_{AT} a terminal processing time of APP-A. Specifically, the terminal device 110 calculates the unknown server processing time T_{AS} of APP-A from these parameters in accordance with the following formula (1) of estimation method #1.

$${T}_{AS} = {T}_{AT} \times \frac{{T}_{BS}}{{T}_{BT}} \qquad ( 1 )$$

ii) Estimation Method #2

Estimation method #2 is for a terminal device 110 (referred to as the first terminal) to estimate a server processing time T_{AS} by using measurement records obtained, not at the terminal device 110 itself, but at another terminal device (referred to as the second terminal). More specifically, the calculation in estimation method #2 is based on the assumption that the ratio of processing times between two different applications does not much depend on which device executes them.

For example, estimation method #2 may be used to estimate an unknown server processing time T_{AS} of application APP-A, when there is a record indicating server processing time T_{BS} of APP-B, as well as records indicating terminal processing times T_{xAT} and T_{xBT} of APP-A and APP-B measured at the second terminal. Specifically, the terminal device 110 calculates the server processing time T_{AS} from the server processing time T_{BS}, and terminal processing times T_{xAT} and T_{xBT} of the second terminal in accordance with the following formula (2) of estimation method #2.

$${T}_{AS} = {T}_{BS} \times \frac{{T}_{xAT}}{{T}_{xBT}} \qquad ( 2 )$$

### (H) PARALLEL EXECUTION

The above-described estimation methods #1 and #2 are not always applicable. For example, neither of these methods can be used when there is no record of server processing time T_{BS} for APP-B, as seen in FIG. 10. Even if there is a record of server processing time T_{BS} for APP-B, estimation methods #1 and #2 do not work when the stored records lack at least one of terminal processing times T_{AT} and T_{BT} of the first terminal, and at least one of terminal processing times T_{xAT} and T_{xBT} of the second terminal. In these cases, both the terminal device 110 and server device 130 execute processing operations in the augmentable section of APP-A. By so doing, the terminal device 110 and server device 130 produce records of terminal processing time and server processing time for APP-A, thus making it possible to consult the records in the next chance of determining whether to use augmented execution for APP-A.

As an alternative option for when neither of estimation methods #1 and #2 is applicable, the terminal device 110 may be configured to substitute a predetermined time length for a server processing time record when making decisions for augmented execution.

### (I) INFORMATION USED

The terminal device 110 and server device 130 may execute particular applications repeatedly. This means that a plurality of records are produced, as seen in FIG. 9, for both terminal processing time and server processing time of a single application. The above-described estimation methods #1 and #2 may therefore be configured to use the average, mode (most often), or latest value of those past measurements of server processing time, rather than using each raw record of the same. The same applies to the terminal processing times.

### (J) CONSIDERATION OF LOAD CONDITION

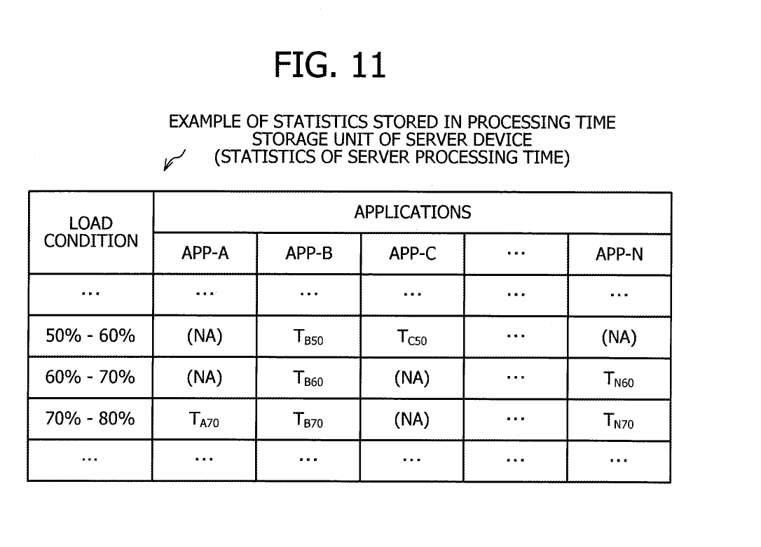

Referring now to FIG. 11, this section describes how the terminal device 110 takes load condition of the server device 130 into consideration when estimating a server processing time. FIG. 11 illustrates an example of statistical records stored in a processing time storage unit of the server device according to the second embodiment.

When determining whether to delegate processing operations in an augmentable section to the server device 130, the terminal device 110 may compares itself with the server device 130 in terms of which one can provide an execution result more quickly. For example, a relevant past record of server processing time is compared with that of terminal processing time. Here the terminal device 110 will be able to make a more appropriate determination by choosing a record of server processing time, taking into consideration the load condition under which the same application was executed.

To achieve the above, the terminal device 110 requests the server device 130 for a server processing time record relevant to the current load condition of the server device 130. As discussed previously in FIG. 9, the processing time storage unit 135 stores server processing times together with their corresponding load condition of the server device 130. In response to the request from the terminal device 110, the server device 130 searches its processing time storage unit 135 to find a record corresponding the current load condition.

When a relevant record is found, the server device 130 provides the terminal device 110 with the server processing time record. When, on the other hand, no relevant records are found, the terminal device 110 estimates a server processing time expected under the current load condition. The estimation method used in this case is referred to as “estimation method #3.” Estimation method #3 may be executed in combination with estimation methods #1 and #2 discussed above.

As illustrated in FIG. 9, the processing time storage unit 135 stores a plurality of server processing time records for a single application executed under different load conditions. This fact may suggest some ways to use statistical records of server processing time. One way is, for example, to extract past measurements of server processing time of APP-B whose average CPU usage (load condition) is within the range of 50% to 60% and calculate the average or median of the extracted measurements. The terminal device 110 uses this value as a statistical record of server processing time. Here the calculation of average or median values is executed by the server processing time management unit 134. The resulting collection of statistical records is stored in the processing time storage unit 135 as seen in FIG. 11.

For example, T_{B50} in the table of FIG. 11 represents a statistical record of server processing time for application APP-B executed when the average CPU usage (load condition) is within the range of 50% to 60%. The illustrated table contains the label “(NA)” (not available) in several cells, denoting that there are no records of server processing time for their corresponding applications and load ranges. For example, “(NA)” is placed when no measurements of server processing time have been done in a certain range of load condition, and when it is not possible to use estimation methods #1 and #2 for that server processing time.

Estimation method #3 is used to estimate such server processing times marked “(NA)” from other existing statistical records in the same processing time storage unit 135. Think of, for example, an unknown statistical data value T_{C70} of server processing time for APP-C with an average CPU usage (load condition) of 70% to 80%. This value T_{C70} is estimated from three existing statistical records T_{B50}, T_{B70}, and T_{C50} in the table of FIG. 11 according to, for example, the following formula (3).

$${T}_{C 70} = {T}_{B 70} \times \frac{{T}_{C 50}}{{T}_{B 50}} \qquad ( 3 )$$

As can be seen from the above example, estimation method #3 may permit the terminal device 110 to obtain an appropriate estimate of unknown statistical values of server processing time, even when there are no past measurements for the load range of interest, and estimation methods #1 and #2 are not applicable.

### (K) MEASUREMENT OF COMMUNICATION TRAFFIC

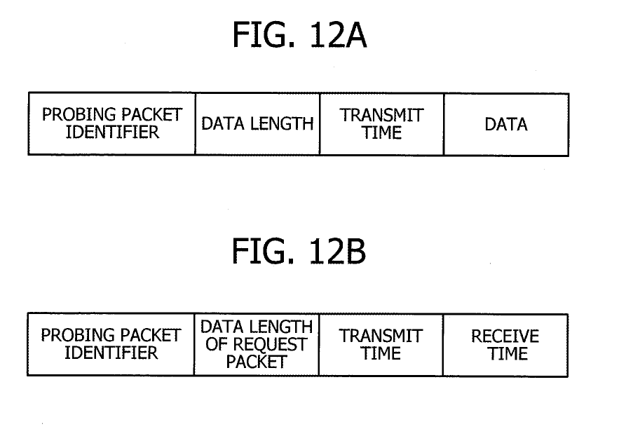

FIGS. 12A and 12B illustrate an example of probing packets used in a proposed method for determining the network condition according to the second embodiment. The network condition is evaluated by measuring the time consumed in transmission of a predetermined amount of data from the terminal device 110 to the server device 130. For example, the packets illustrated in FIGS. 12A and 12B may be used to measure this data transmission time. Specifically, FIG. 12A illustrates a request packet that the terminal device 110 sends to the server device 130. FIG. 12B, on the other hand, illustrates a reply packet that the server device 130 returns to the terminal device 110.

Referring to FIG. 12A, the illustrated request packet includes the following fields: “Probing Packet Identifier,” “Data Length,” “Transmit Time,” and “Data.” This request packet carries a fixed amount of data, whose content may be, but not limited to, null (e.g., 0x00). The probing packet identifier field contains a value that identifies the packet as being a request packet. The data length field indicates the length of data contained in the request packet. The transmit time field contains a timestamp indicating when the terminal device 110 transmitted the request packet.

Referring to FIG. 12B, the illustrated reply packet includes the following fields: “Probing Packet Identifier,” “Request Packet Data Length,” “Transmit Time,” and “Receive Time.” This reply packet is transmitted from the server device 130 to the terminal device 110 in response to a request packet received from the latter. The probing packet identifier field contains the same value as its counter part of the request packet. The request packet data length field contains what is contained in the data length field of the request packet. The transmit time field contains the same timestamp as its counterpart of the request packet. The receive time field contains a timestamp indicating when the server device 130 received the request packet.

Upon receipt of a reply packet, the terminal device 110 calculates a data transmission time (i.e., the amount of time spent for transmission) of the request packet on the basis of transmission and reception timestamps contained in the received reply packet. The terminal device 110 further calculates a transmission rate (e.g., data transmission time per unit data length) of the request packet, using the calculated data transmission time and the request packet's data length indicated in the received reply packet.

The terminal device 110 can estimate the amount of time for transmitting state data in augmented execution by multiplying the state data size by the transmission rate. It is also possible to estimate the amount of time for transmitting an application program to the server device 130 by multiplying its code size by the transmission rate, when the server device 130 needs such transmission for the purpose of augmented execution. These two estimates are then added to a relevant server processing time that was measured in the past. The resulting sum is used as an estimate of processing time for the server device 130 to finish the augmentable section under the current network condition.

### (L) VARIATIONS OF AUGMENTED EXECUTION

This section provides several variations of the second embodiment discussed above.

i) First Variation

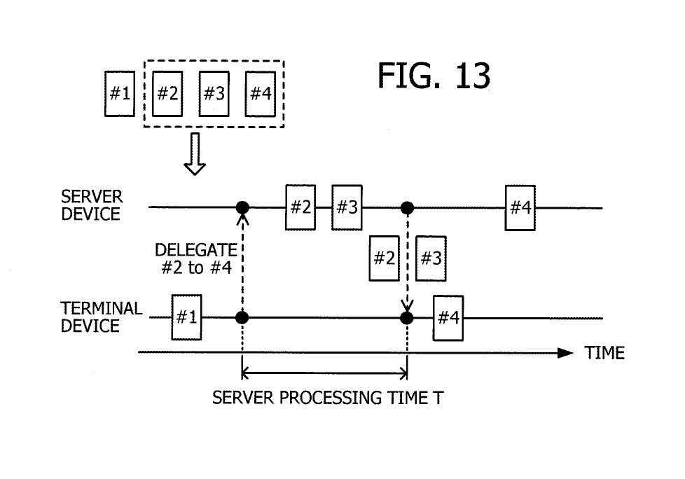

FIG. 13 illustrates a variation of the augmented execution according to the second embodiment. In the example of FIG. 13, the terminal device 110 has four processing operations #1 to #4 to execute, of which three processing operations #2 to #4 are subjected to augmented execution. Specifically, the terminal device 110 first executes processing operation #1 and then initiates augmented execution by off-loading the remaining three processing operations #2 to #4 to the server device 130. According to the foregoing second embodiment, the terminal device 110 starts processing operations #2 to #4 upon expiration of a server processing time T that is estimated. The first variation is different from the original embodiment in that the terminal device 110 uses an intermediate result of the server device 130 at the moment of expiration of the server processing time T.

For example, the terminal device 110 is configured to request the server device 130 to send its state data, upon expiration of the server processing time T. In response to this request, the server device 130 holds (stops temporarily) execution of the application and saves its state data. The server device 130 then sends a copy of the saved state data back to the requesting terminal device 110. The received state data permits the terminal device 110 to start the remaining processing operation #4.

With the above method of the first variation, the terminal device 110 can reduce its own processing load by the amount equivalent to the delegated processing operations #2 and #3. This reduction of load also leads to a less battery consumption in the terminal device 110, as well as faster delivery of execution results of processing operation #4.

ii) Second Variation

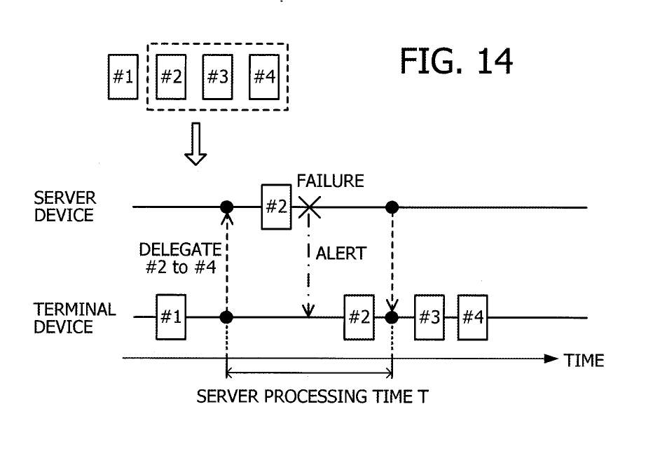

FIG. 14 is a first diagram illustrating a variation of how the second embodiment may deal with a problem encountered during augmented execution in the server device. The context is that the server device 130 encounters some failure during a processing operation as part of the augmented execution of an application. For example, the application hangs up before the execution reaches the next checkpoint. Here the server device 130 is unable to respond to the terminal device 110 since it is unlikely that the checkpoint is reached.

According to the foregoing second embodiment, the terminal device 110 would wait until an estimated server processing time expires, before it starts the failed processing. The second variation differs from the original embodiment in that the terminal device 110 starts its processing even before expiration of the estimated server processing time T.

For example, the above failure of processing causes the server device 130 to send an alert to the terminal device 110. In response, the terminal device 110 starts processing operations #2 to #4 in the augmentable section without waiting for expiration of the estimated server processing time T.

As seen from the above example, the second variation permits the terminal device 110 to start processing operation #2 before the server processing time T is reached. It is therefore possible for the terminal device 110 to output the result of processing operations #2 to #4 in a shorter time than in the case of starting after the server processing time T.

iii) Third Variation

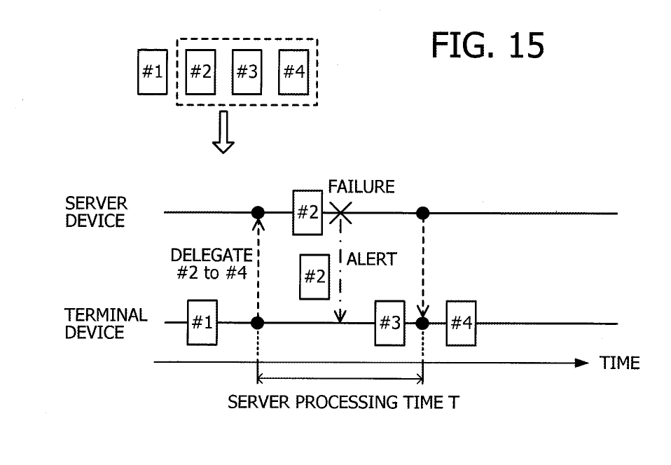

FIG. 15 is a second diagram illustrating a variation of how the second embodiment may deal with a problem encountered during augmented execution in the server device. The third variation is similar to the second variation in that the terminal device 110 starts processing without waiting for the expiration of an estimated server processing time T even when the server device 130 encounter a failure. The difference of the third variation is that, as seen in FIG. 15, the server device 130 sends its state data to the terminal device 110 together with an alert indicating the failure. The terminal device 110 uses the received state data to start the remaining processing operations (#3 and #4 in the example of FIG. 15).

The above third variation eliminates the need for the terminal device 110 to re-execute the processing operation #2 that has been finished by the server device 130 before it hangs. This feature alleviates the load on the terminal device 110 and thus leads to a reduced consumption of the battery power, as well as enabling faster delivery of execution results of processing operation #4.

As a possible modification to the third variation, the server device 130 may be configured to send its state data to the terminal device 110 at regular intervals, rather than sending it upon failure. In this case, the terminal device 110 is allowed to safely start processing operations of an augmentable section by using the latest copy of state data received from the server device 130 before it hangs.

### (M) OPERATION OF TERMINAL AND SERVER DEVICES

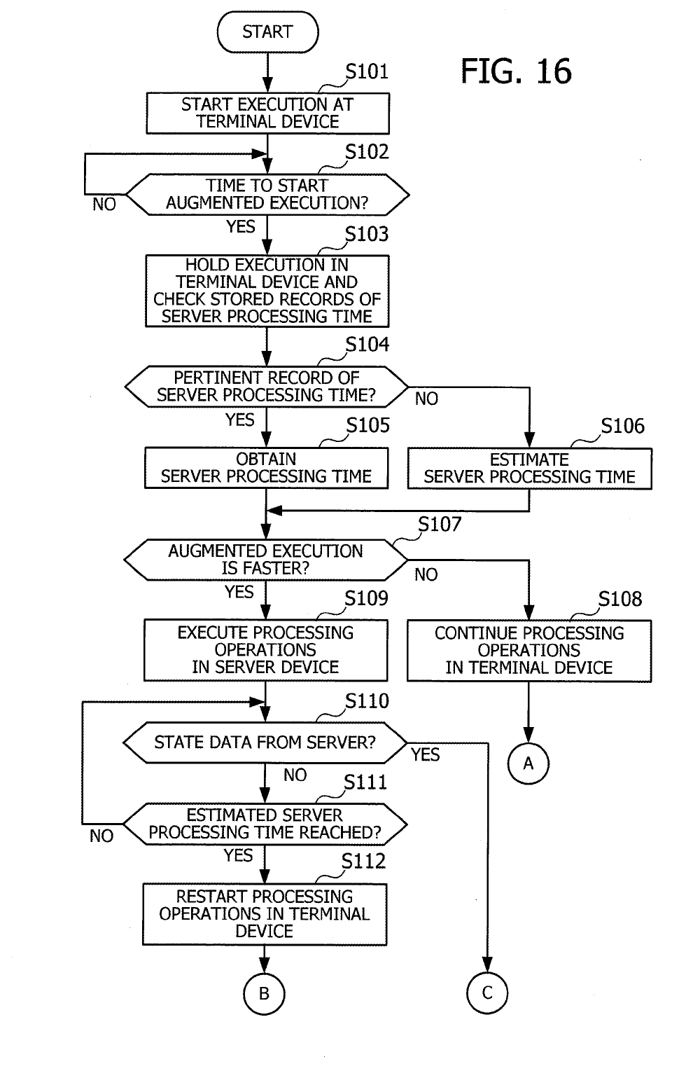

FIG. 16 is a first diagram illustrating an example of how the terminal device 110 and server device 130 work together according to the second embodiment.

(S101) The terminal device 110 starts to execute an application. For example, the terminal device 110 may be configured to start predetermined applications upon bootup. The terminal device 110 may also start an application specified and initiated by the user.

At the start of each application, the terminal device 110 determines whether to use augmented execution for the application. For example, some applications are previously configured to run with the aid of augmented execution. If this is the case for the present application, the terminal device 110 then determines to subject its augmentable section to the augmented execution. If not, the terminal device 110 is to execute all processing operations of the application by itself. The following description assumes that augmented execution is enabled in the application.

(S102) The terminal device 110 determines whether it is time to start augmented execution. For example, the terminal device 110 triggers augmented execution when the augmentable section of the application is reached. The augmentable section may be defined in the application itself, or may be described in configuration files stored in the terminal device 110 and server device 130. When the augmentable section is reached, the process moves forward to S103. Otherwise, the terminal device 110 repeats S102 while continuing the application.

Alternatively, the terminal device 110 may start augmented execution in response to a user command, in which case the terminal device 110 proceeds to S103 upon receipt of the command. Such user commands may be entered to the terminal device 110 or may be provided via the server device 130.

(S103) The terminal device 110 holds execution of the application, saves its state data, and then checks server processing time records stored in the server device 130. For example, the terminal device 110 sends a query to the server device 130 for a record of server processing time pertinent to the application now in the pending state, in the expectation that the server device 130 measured the time its execution in the past. The server device 130 responds to the query by indicating whether there is a pertinent record of server processing time.

(S104) When the response received at S103 indicates the presence of a pertinent record, the terminal device 110 advances to S105. When the response indicates the absence of a pertinent record, the terminal device 110 proceeds to S106.

(S105) The terminal device 110 obtains the requested record from the server device 130 as a response to the query of S103. The terminal device 110 now expects that server device 130 will finish the augmentable section in the server processing time indicated by the obtained records, thus moving to S107. The server processing time indicated in the received record is referred to herein as an “estimated server processing time.”

(S106) The terminal device 110 retrieves its own records of terminal processing time, as well as obtaining records of server processing time that the server device 130 stores for other applications. Based on those records of terminal and server processing times, the terminal device 110 estimates an unknown server processing time of the present application. For example, the terminal device 110 uses the foregoing estimation method #1 or #2 to achieve the purpose. This step S106 thus produces an estimate of the server processing time, which is also referred to herein as an “estimated server processing time.”

(S107) The terminal device 110 checks the current network condition. For example, the terminal device 110 measures a data transmission time by exchanging the foregoing probing packets with the server device 130.

The terminal device 110 requests the server device 130 for a server processing time record that matches with the current load condition of the server device 130. In response, the server device 130 checks its own load condition (e.g., average CPU usage) at present and searches the records of server processing time to find the one pertinent to the current load condition. When there is no pertinent record of such a load-dependent server processing time, the server device 130 estimates the server processing time with the foregoing estimation method #3. When a pertinent record is found, the server device 130 informs the terminal device 110 of the load-dependent server processing time extracted from the record.

With the pertinent record received from the server device 130, the terminal device 110 then adds the data transmission time measured above to the obtained load-dependent server processing time, thereby making a first time estimate. The terminal device 110 compares this first time estimate with its own terminal processing time. When, on the other hand, no pertinent record is obtained from the server device 130, the terminal device 110 adds the data transmission time to the estimated server processing time of S105 or S106, thereby making a second time estimate. The terminal device 110 compares this second time estimate with its own terminal processing time.

When the above first or second time estimate is greater than the terminal processing time, the terminal device 110 goes to S108. When the above first or second time estimate is smaller than the terminal processing time, the terminal device 110 goes to S109.

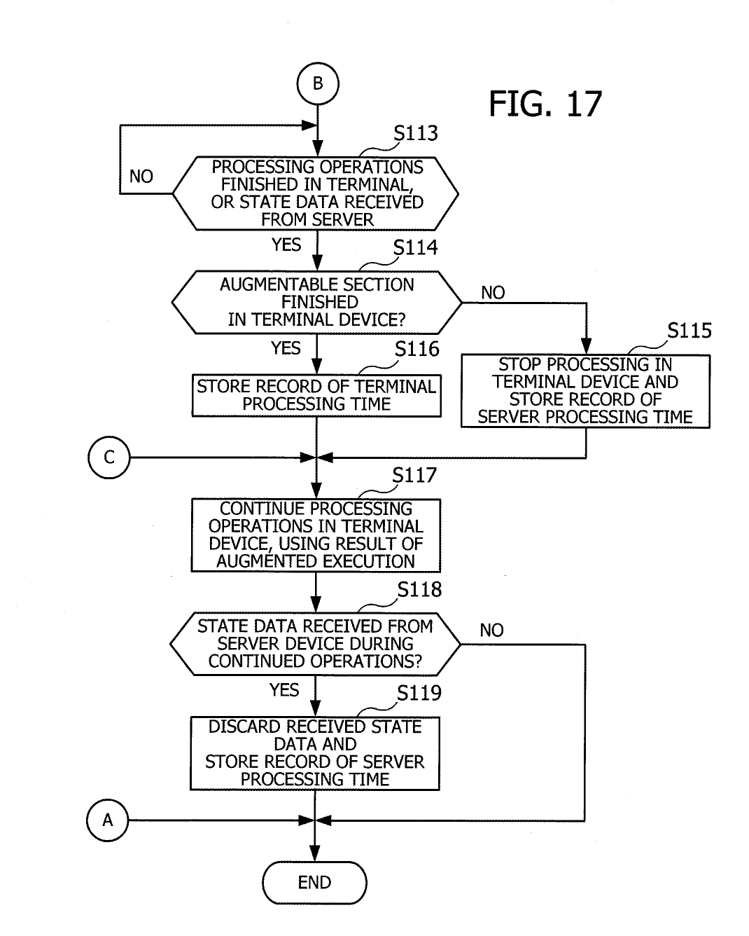

(S108) The terminal device 110 continues to execute the application by itself, including processing operations in the augmentable section. The procedure of FIGS. 16 and 17 comes to an end upon completion of the application in the terminal device 110.

(S109) The terminal device 110 sends state data to the server device 130. With the received state data, the server device 130 starts to execute processing operations in the augmentable section. The server device 130 also starts counting its own processing time. When the execution of the augmentable section is finished, the server device 130 stops counting of the server processing time and saves the current state data. The server device 130 sends a copy of this state data to the terminal device 110.

(S110) The terminal device 110 determines whether it has received state data from the server device 130. When it has received state data, the terminal device 110 proceeds to S117 seen in FIG. 17. When it has not yet received state data, the terminal device 110 advances to S111.

(S111) The terminal device 110 checks the amount of time that has elapsed since the transmission of state data to the server device 130 and compares the time with the second time estimate described above. When the second time estimate has been reached, the terminal device 110 advances to S112. When the second predicted time has not been reached, terminal device 110 goes back to S110.

(S112) The terminal device 110 starts to execute processing operations in the augmentable section, as well as counting its own processing time. The terminal device 110 proceeds to S113 seen in FIG. 17.

FIG. 17 is a second diagram illustrating an example of how the terminal device 110 and server device 130 work together according to the second embodiment.

(S113) The terminal device 110 advances to S114 when it has finished the augmentable section by itself, or when state data is received from the server device 130. Otherwise, the terminal device 110 repeats S113.

(S114) When the terminal device 110 has finished the augmentable section by itself, the terminal device 110 moves to S116 after terminating the counting of terminal processing time. When state data has been received from the server device 130, the terminal device 110 simply advances to S115.

(S115) The terminal device 110 stops execution of the augmentable section, terminates counting of the terminal processing time, and then proceeds to S117. That is, the terminal device 110 quits ongoing processing operations of the augmentable section and skips forward at the point in time when state data is received from the server device 130. The server device 130, on the other hand, saves a record of its server processing time upon completion of the augmentable section.

(S116) The terminal device 110 saves a record of its own terminal processing time, besides sending the same to the server device 130. The terminal device 110 then advances to S117.

(S117) The terminal device 110 executes the remaining processing operations that follow the augmentable section. The terminal device 110 may have received state data from the server device 130. When this is the case, the terminal device 110 uses the received state data to execute the remaining processing operations. For example, the terminal device 110 overwrites its stack and heap areas with the received state data before starting execution of the remaining processing operations.

The terminal device 110 may have otherwise finished the augmentable section by itself. When this is the case, the stack and heap areas of the terminal device 110 stores the execution result of the augmentable section. Accordingly, the terminal device 110 simply continues executing the application.

(S118) The terminal device 110 determines whether state data is received from the server device 130 during the execution of remaining processing operations. This test returns false in the case where the terminal device 110 has already received state data from the server device 130. The procedure of FIGS. 16 and 17 comes to an end upon completion of the application in the terminal device 110.

On the other hand, in the case where the terminal device 110 has finished the augmentable section without receiving state data from the server device 130, there is still a chance for the terminal device 110 to receive such state data during execution of the remaining processing operations. When this really happens, the terminal device 110 advances to S119.

(S119) The terminal device 110 discards the state data received from the server device 130. The server device 130, on the other hand, saves a record of its server processing time of the finished augmentable section. The procedure of FIGS. 16 and 17 reaches its end upon completion of the application in the terminal device 110.

The above section has presented an example of how the terminal device 110 and server device 130 work. The next section will focus on the operation of the execution management unit 112.

### (N) OPERATION OF EXECUTION MANAGEMENT UNIT

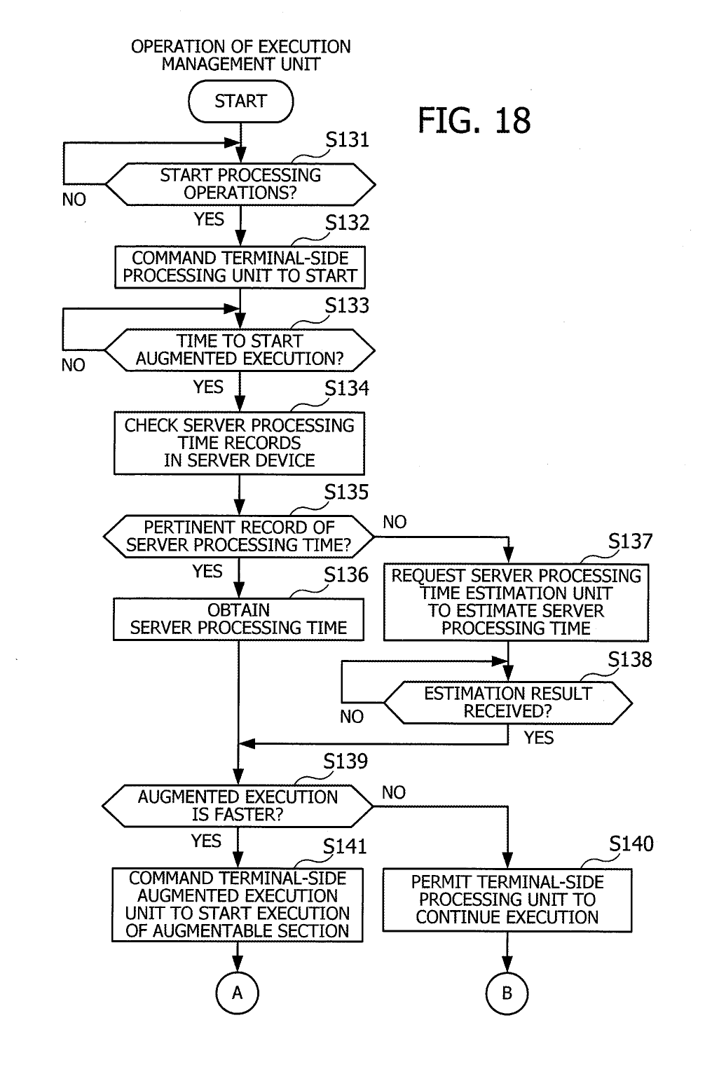

FIG. 18 is a first diagram illustrating an example of how the execution management unit 112 works in the terminal device according to the second embodiment. Specifically, the execution management unit 112 operates as follows.

(S131) The execution management unit 112 determines whether to start execution of a given application. For example, the terminal device 110 may previously be configured to start predetermined applications upon booting. In this case, the execution management unit 112 moves to S132 when the terminal device 110 starts up. The execution management unit 112 also moves to S132 upon receipt of a user command that requests execution of a specific application.

At the start of an application, the execution management unit 112 determines whether to use augmented execution for the application. For example, some applications are previously configured to run with the aid of augmented execution. If this is the case for the present application, the execution management unit 112 then determines to subject its augmentable section to the augmented execution. Otherwise, the execution management unit 112 determines to execute the whole application with the terminal-side processing unit 111 alone. The following description assumes that augmented execution is enabled in the application.

(S132) The execution management unit 112 commands the terminal-side processing unit 111 to start to execute the application.

(S133) The execution management unit 112 determines whether it is time to start augmented execution. For example, the terminal device 110 triggers augmented execution when the augmentable section of the application is reached. The augmentable section may be defined in the application itself, or may be described in configuration files stored in the terminal device 110 and server device 130. The execution management unit 112 waits for the terminal-side processing unit 111 to reach the augmentable section. The execution management unit 112 then proceeds to S134.

Alternatively, the terminal device 110 may start augmented execution in response to a user command, in which case the terminal device 110 proceeds to S134 upon receipt of the command. Such user commands may be entered to the terminal device 110 or may be provided via the server device 130.

(S134) The execution management unit 112 checks server processing time records stored in the server device 130. For example, the execution management unit 112 sends a query to the server device 130 for a record of server processing time pertinent to the application subjected to augmented execution, expecting that the server device 130 measured the time its execution in the past.

(S135) When the server device 130 responds at S134 that there is a pertinent record of server processing time, the execution management unit 112 advances to S136. When the response indicates that there is no such record, the execution management unit 112 proceeds to S137.

(S136) The execution management unit 112 obtains the requested server processing time record from the server device 130 as a response to the query of S134. Upon receipt, the execution management unit 112 advances to S139.

(S137) The execution management unit 112 requests the server processing time estimation unit 114 to estimate the unknown server processing time.

(S138) The execution management unit 112 waits until the server processing time estimation unit 114 comes back with an estimate of the server processing time, and then proceeds to S139.

(S139) The execution management unit 112 checks the current network condition. For example, the execution management unit 112 causes the communication unit 115 to measure a data transmission time by exchanging the foregoing probing packets with the server device 130.

The execution management unit 112 requests the server device 130 for a server processing time record that matches with the current load condition of the server device 130. With the pertinent record of a load-dependent server processing time received from the server device 130, the execution management unit 112 compares a first time estimate (the sum of data transmission time and load-dependent server processing time) with its own terminal processing time stored in the processing time storage unit 113.

When, on the other hand, no pertinent record is obtained from the server device 130, the execution management unit 112 compares a second time estimate (the sum of data transmission time and server processing time obtained at S136 or estimated at S106) with its own terminal processing time stored in the processing time storage unit 113.

When the above first or second time estimate is greater than the terminal processing time, the execution management unit 112 goes to S140. When the above first or second time estimate is smaller than the terminal processing time, the execution management unit 112 goes to S141.

In the case where the processing time storage unit 113 contains no relevant records of terminal processing time, the execution management unit 112 uses a predetermined threshold, instead of a past record of terminal processing time, in the above comparison of the first or second predicted time. When the first or second time estimate is greater than the predetermined threshold, the execution management unit 112 advances to S140. When the first or second time estimate is smaller than the predetermined threshold, the execution management unit 112 advances to S141.

(S140) The execution management unit 112 permits the terminal-side processing unit 111 to continue its execution of the application, including processing operations in the augmentable section.

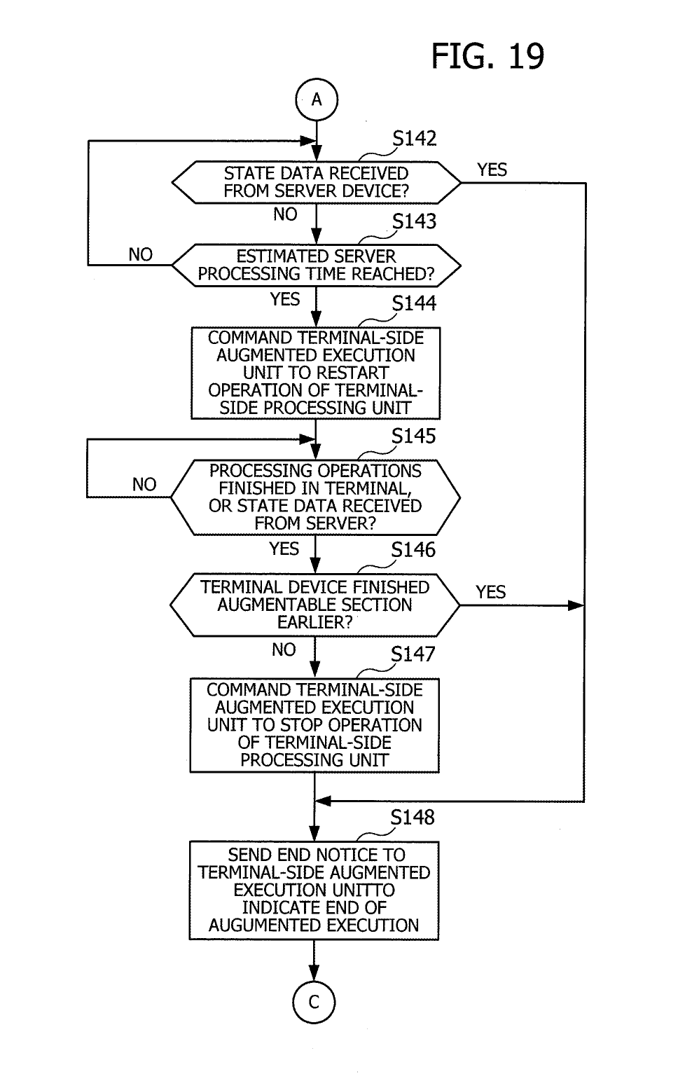

(S141) The execution management unit 112 commands the terminal-side augmented execution unit 116 to start execution of the augmentable section and proceeds to S142 seen in FIG. 19.

FIG. 19 is a second diagram illustrating an example of how the execution management unit 112 works in the terminal device according to the second embodiment.

(S142) The execution management unit 112 determines whether it has received state data from the server device 130. When state data has been received, the execution management unit 112 skips to S148. When state data has not yet been received, the execution management unit 112 advances to S143.

(S143) The execution management unit 112 checks the amount of time that has elapsed since the command issued at S141 for starting execution. The execution management unit 112 then compares the elapsed time with the second time estimate described above. When the second time estimate has been reached, the execution management unit 112 advances to S144. When the second time estimate has not yet been reached, the execution management unit 112 returns to S142.

(S144) The execution management unit 112 requests the terminal-side augmented execution unit 116 to restart operation of the terminal-side processing unit 111. That is, the execution management unit 112 commands the terminal-side augmented execution unit 116 to make the terminal-side processing unit 111 start execution of the augmentable section.

(S145) The execution management unit 112 waits until the terminal-side processing unit 111 finishes execution of the augmentable section, or until state data is received from the server device 130. The execution management unit 112 then advances to S146.

(S146) Upon confirmation of finished execution of the augmentable section at S145, the execution management unit 112 skips to S148. When, on the other hand, state data from the server device 130 is received at S145 before the terminal-side processing unit 111 finishes execution of the augmentable section, the execution management unit 112 advances to S147.

(S147) The execution management unit 112 requests the terminal-side augmented execution unit 116 to stop operation of the terminal-side processing unit 111. That is, the execution management unit 112 commands the terminal-side augmented execution unit 116 to make the terminal-side processing unit 111 stop execution of the augmentable section.

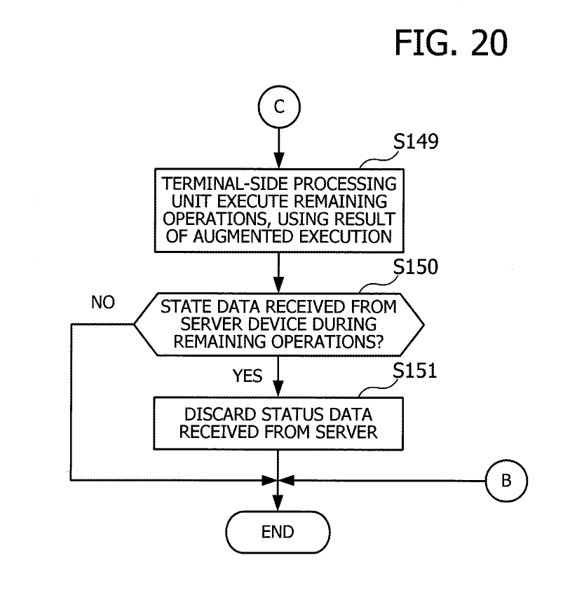

(S148) The execution management unit 112 sends an end notice to the terminal-side augmented execution unit 116 to indicate that the augmented execution has finished. The execution management unit 112 then proceeds to S149 seen in FIG. 20.

FIG. 20 is a third diagram illustrating an example of how the execution management unit 112 works in the terminal device according to the second embodiment.

(S149) The execution management unit 112 permits the terminal-side processing unit 111 to move forward and execute remaining processing operations that follows the augmentable section, using the result of augmented execution of the augmentable section.

(S150) Even in the case where the terminal-side processing unit 111 has finished execution of the augmentable section before state data comes from the server device 130, there is still a chance for the execution management unit 112 to receive such state data with some delay. When this is the case, the execution management unit 112 advances to S151. Otherwise, the execution management unit 112 closes the series of acts discussed in FIGS. 18 to 20.

(S151) The execution management unit 112 discards the state data received from the server device 130 and closes the series of acts discussed in FIGS. 18 to 20.

### (O) OPERATION OF TERMINAL-SIDE AUGMENTED EXECUTION UNIT

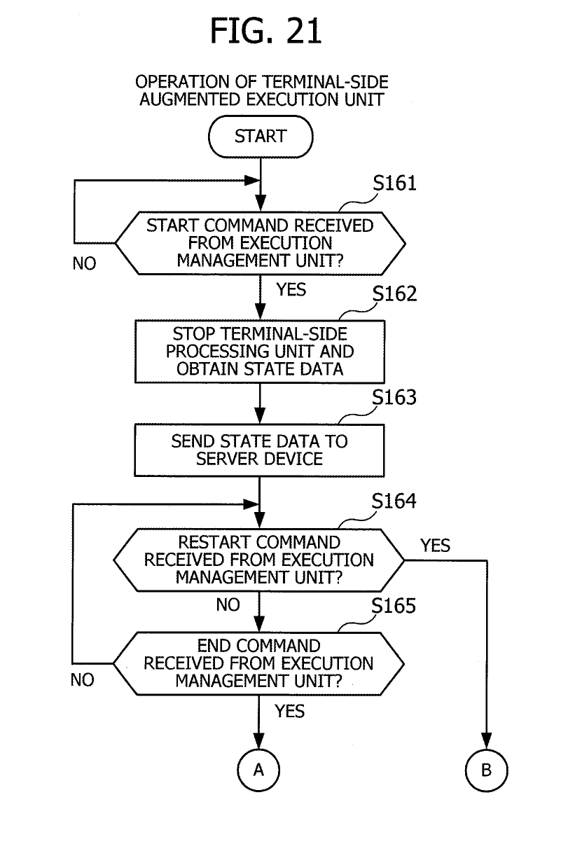

FIG. 21 is a first diagram illustrating an example of how the terminal-side augmented execution unit 116 works in the terminal device 110 according to the second embodiment. Specifically, the terminal-side augmented execution unit 116 operates as follows.

(S161) The terminal-side augmented execution unit 116 waits for a start command from the execution management unit 112 for executing processing operations in a given augmentable section. Upon receipt of this start command, the terminal-side augmented execution unit 116 advances to S162.

(S162) The terminal-side augmented execution unit 116 stops operation of the terminal-side processing unit 111 and obtains state data that the terminal-side processing unit 111 has stored. For example, the terminal-side augmented execution unit 116 obtains data from stack and heap areas of the terminal-side processing unit 111.

(S163) The terminal-side augmented execution unit 116 sends the state data obtained at S162 to the server device 130.

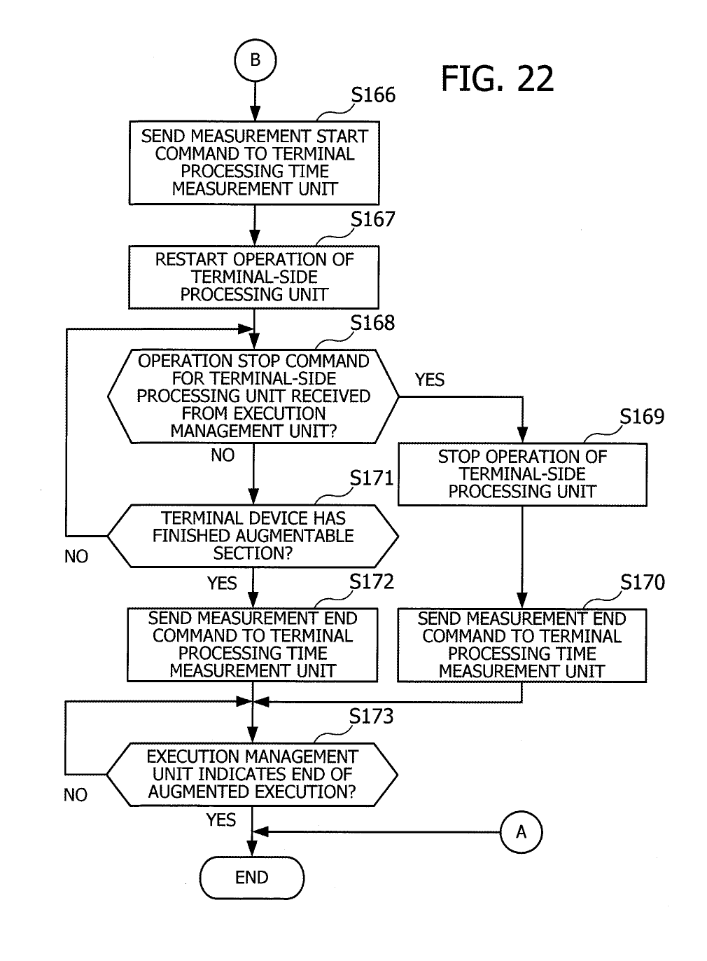

(S164) The terminal-side augmented execution unit 116 determines whether a restart command has been received from the execution management unit 112 which requests the terminal-side processing unit 111 to execute processing operations in the given augmentable section. When a restart command has been received, the terminal-side augmented execution unit 116 proceeds to S166 seen in FIG. 22. When no such command is received, the terminal-side augmented execution unit 116 advances to S165.

(S165) The terminal-side augmented execution unit 116 determines whether an end command has been received from the execution management unit 112 which requests to end the processing operations in the given augmentable section. This end command, when received, causes the terminal-side augmented execution unit 116 to close the series of acts described in FIGS. 21 and 22. The terminal-side augmented execution unit 116 otherwise goes back to S164.

FIG. 22 is a second diagram illustrating an example of how the terminal-side augmented execution unit 116 works in the terminal device 110 according to the second embodiment.

(S166) The terminal-side augmented execution unit 116 sends a measurement start command to the terminal processing time measurement unit 117 to start measurement of a terminal processing time.

(S167) The terminal-side augmented execution unit 116 commands the terminal-side processing unit 111 to execute processing operation of the augmentable section. It is noted that S167 may be executed before S166.

(S168) The terminal-side augmented execution unit 116 determines whether an operation stop command has been received from the execution management unit 112 which requests to stop the terminal-side processing unit 111. This operation stop command, when received, causes the terminal-side augmented execution unit 116 to proceed to S169. The terminal-side augmented execution unit 116 otherwise advances to S171.

(S169) The terminal-side augmented execution unit 116 commands the terminal-side processing unit 111 to stop its operation even in the middle of execution of the augmentable section.

(S170) The terminal-side augmented execution unit 116 sends a measurement end command to the terminal processing time measurement unit 117 to terminate the measurement of a terminal processing time. The terminal-side augmented execution unit 116 then proceeds to S173.

(S171) The terminal-side augmented execution unit 116 determines whether the terminal-side processing unit 111 has finished all processing operations in the augmentable section. When the augmentable section is done by the terminal-side processing unit 111, the terminal-side augmented execution unit 116 advances to S172. When the terminal-side processing unit 111 is still executing the augmentable section, the terminal-side augmented execution unit 116 goes back to S168.

(S172) The terminal-side augmented execution unit 116 sends a measurement end command to the terminal processing time measurement unit 117 to terminate the measurement of a terminal processing time.

(S173) The terminal-side augmented execution unit 116 waits for a notice from the execution management unit 112 that indicates the end of the augmented execution. Upon receipt of this end notice, the terminal-side augmented execution unit 116 closes the series of acts discussed in FIG. 21 and FIG. 22.

### (P) OPERATION OF SERVER PROCESSING TIME ESTIMATION UNIT

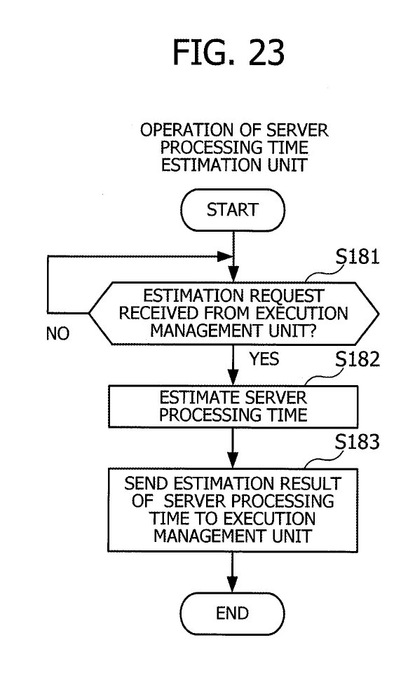

FIG. 23 illustrates an example of how the server processing time estimation unit 114 works in the terminal device 110 according to the second embodiment. Specifically, the server processing time estimation unit 114 operates as follows.

(S181) The server processing time estimation unit 114 waits until an estimation request is received from the execution management unit 112. Upon receipt of this request, the server processing time estimation unit 114 advances to S182.

(S182) The server processing time estimation unit 114 estimates the requested server processing time with the above-described estimation methods #1 and #2. That is, the server processing time estimation unit 114 calculates an estimate of server processing time for the augmentable section in the application that is currently executed, assuming that the server device 130 is to execute processing operations of the augmentable section.

(S183) The server processing time estimation unit 114 informs the execution management unit 112 of the estimation result, i.e., the calculated estimate of server processing time, and thus closing the series of acts discussed in FIG. 23.

### (Q) OPERATION OF TERMINAL PROCESSING TIME MEASUREMENT UNIT

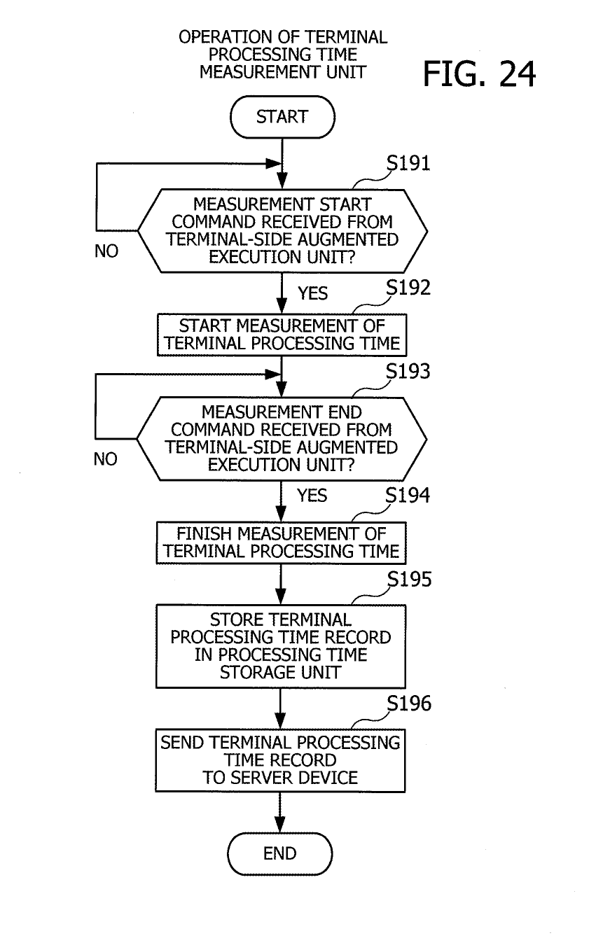

FIG. 24 illustrates an example of how the terminal processing time measurement unit 117 works in the terminal device 110 according to the second embodiment. Specifically, the terminal processing time measurement unit 117 operates as follows.

(S191) The terminal processing time measurement unit 117 waits until a measurement start command is received from the terminal-side augmented execution unit 116. Upon receipt of this command, the terminal processing time measurement unit 117 advances to S192.

(S192) The terminal processing time measurement unit 117 starts measurement of a terminal processing time by counting the elapsed time.

(S193) The terminal processing time measurement unit 117 continues the measurement until a measurement end command is received from the terminal-side augmented execution unit 116. Upon receipt of a measurement end command, the terminal processing time measurement unit 117 proceeds to S194.

(S194) The terminal processing time measurement unit 117 finishes the measurement.

(S195) The terminal processing time measurement unit 117 stores a record of the measured terminal processing time in the processing time storage unit 113.

(S196) The terminal processing time measurement unit 117 sends the record of the measured terminal processing time to the server device 130. It is noted that S196 may be executed before S195. Upon completion of S196, the terminal processing time measurement unit 117 closes the series of acts discussed in FIG. 24.

### (R) OPERATION OF SERVER-SIDE AUGMENTED EXECUTION UNIT

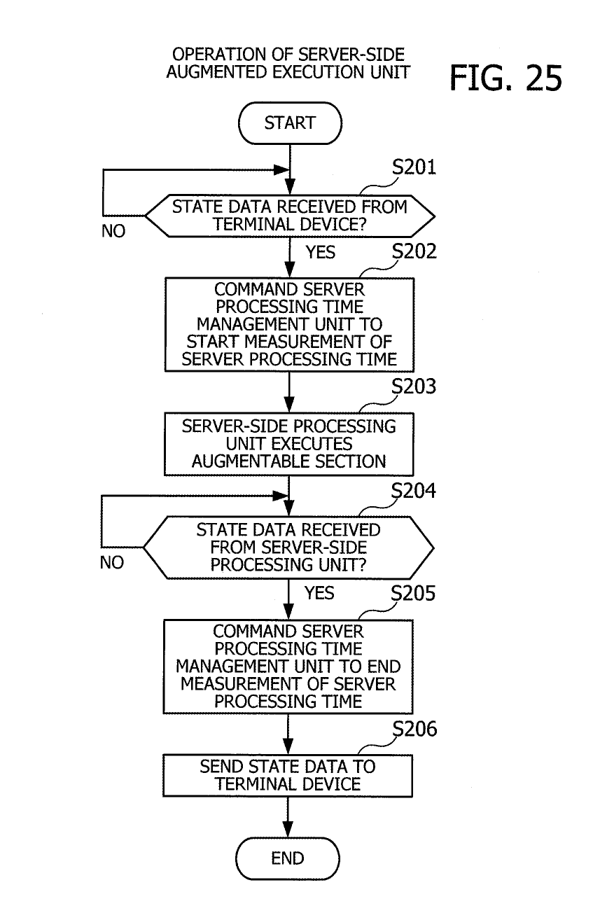

FIG. 25 illustrates an example of how the server-side augmented execution unit 133 works in the server device 130 according to the second embodiment. Specifically, the server-side augmented execution unit 133 operates as follows.

(S201) The server-side augmented execution unit 133 waits until state data is received from the terminal device 110. Upon receipt of state data, the server-side augmented execution unit 133 advances to S202.

(S202) The server-side augmented execution unit 133 sends a measurement start command to the server processing time management unit 134 to start counting a server processing time.

(S203) The server-side augmented execution unit 133 causes the server-side processing unit 132 to execute processing operations in the given augmentable section using the received state data. It is noted that S203 may be executed before S202.

(S204) The server-side augmented execution unit 133 waits until state data is received from the server-side processing unit 132. This state data is what the server-side processing unit 132 is supposed to store at the end of its execution of the augmentable section. Upon receipt of such state data, the server-side augmented execution unit 133 advances to S205.

(S205) The server-side augmented execution unit 133 sends a measurement end command to the server processing time management unit 134 to stop counting the server processing time.

(S206) The server-side augmented execution unit 133 sends the information processing system 100 the state data received from the server-side processing unit 132, thus closing the series of acts discussed in FIG. 25.

### (S) OPERATION OF SERVER PROCESSING TIME MANAGEMENT UNIT

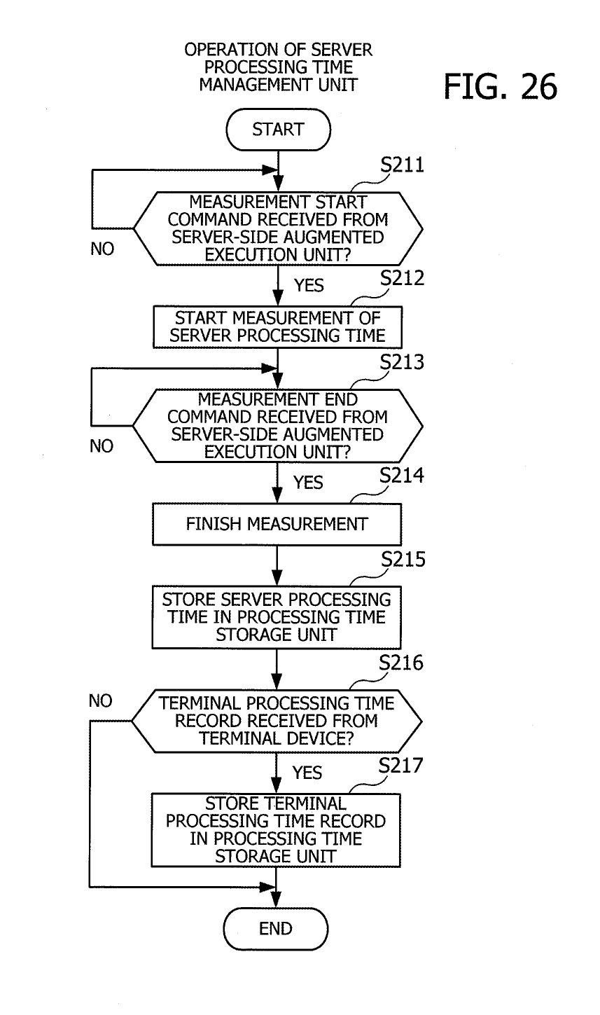

FIG. 26 illustrates an example of how the server processing time management unit 134 works in the server device 130 according to the second embodiment. Specifically, the server processing time management unit 134 operates as follows.

(S211) The server processing time management unit 134 waits until a measurement start command is received from the server-side augmented execution unit 133. Upon receipt of this start command, the server processing time management unit 134 advances to S212.

(S212) The server processing time management unit 134 starts measurement of a server processing time by counting the elapsed time.

(S213) The server processing time management unit 134 continues the measurement until a measurement end command is received from the server-side augmented execution unit 133. Upon receipt of this end command, the server processing time management unit 134 advances to S214.

(S214) The server processing time management unit 134 stops counting the server processing time, thus finishing the measurement.

(S215) The server processing time management unit 134 stores a record of the measured server processing times in the processing time storage unit 135.

(S216) The server processing time management unit 134 determines whether a record of terminal processing time has been received from the terminal device 110. When such a record has been received, the server processing time management unit 134 proceeds to S217. When no such records are received, the server processing time management unit 134 closes the series of acts described in FIG. 26.

(S217) The server processing time management unit 134 stores the terminal processing time record received from the terminal device 110 in the processing time storage unit 135, together with an identifier that indicates the pertinent terminal device 110. The server processing time management unit 134 then closes the series of acts described in FIG. 26.

### (T) CONCLUSION

The second embodiment, including its variations, has been described above. According to the second embodiment, a terminal device 110 delegates processing operations of an augmentable section to a server device 130 for augmented execution. The second embodiment enables the terminal device 110 to quickly start to execute processing operations of the augmentable section even if the server device 130 is unable to provide the execution result within an expected server processing time. This feature of the second embodiment reduces the risk of a serious delay of execution result of applications.

While estimation of server processing times is performed by the terminal device 110 in some of the above-described examples, the scope of the embodiments is not limited by those specific examples. It is possible, for example, to modify the proposed mechanisms such that the server device 130 estimates server processing times. The embodiments may also be modified with respect to the data transmission time. For example, the amount of time for transmitting data from the server device 130 to the terminal device 110 may be taken into consideration in addition to the data transmission time from the terminal device 110 to the server device 130. All those variations are included in the scope of the foregoing second embodiment.

Various embodiments and their variations have been discussed above. According to an aspect of those embodiments, the proposed techniques reduce the risk of a considerable delay of execution result of applications.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A distributed processing method executed in a system formed from a first information processing apparatus and a second information processing apparatus, the distributed processing method comprising:
requesting, by a processor in the first information processing apparatus, the second information processing apparatus to execute a processing operation off-loaded from the first information processing apparatus, while the first information processing apparatus is capable of executing the processing operation;
determining, by the processor, whether an amount of elapsed time since the requesting exceeds a threshold before an execution result of the processing operation is obtained from the second information processing apparatus;
starting, by the processor, to locally execute the processing operation in the first information processing apparatus when the amount of elapsed time is determined to have exceeded the threshold; and
using a local execution result of the processing operation executed by the first information processing apparatus or the execution result obtained from the second information processing apparatus, whichever comes earlier.

2. The distributed processing method according to claim 1, wherein:
the processing operation is a second part of a software program which follows a first part of the software program;
the method further comprises executing the first part of the software program by the processor before the requesting is performed, and stopping execution of the software program temporarily before proceeding to the second part thereof; and
the starting of the processing operation in the first information processing apparatus includes restarting, by the processor, execution of the software program that is temporarily stopped.

3. The distributed processing method according to claim 1, wherein:
the execution result obtained from the second information processing apparatus includes data indicating a state of memory content of the second information processing apparatus at a point in time when the processing operation is finished in the second information processing apparatus; and
the method further comprises updating, by the processor, memory content of the first information processing apparatus with the data indicating the state of memory content of the second information processing apparatus, besides stopping the processing operation in the first information processing apparatus, when the execution result is obtained from the second information processing apparatus before the first execution result is produced in the first information processing apparatus.

4. The distributed processing method according to claim 1, further comprising:
sending an intermediate result of the processing operation from the second information processing apparatus to the first information processing apparatus, when the amount of elapsed time is determined to have exceeded the threshold; and
receiving, by the processor, the intermediate result from the second information,
wherein the starting of the processing operation in the first information processing apparatus includes taking over, by the processor, the execution of the processing operation from the second information processing apparatus by using the received intermediate result.

5. The distributed processing method according to claim 1, further comprising calculating, by the processor, the threshold as a time that the second information processing apparatus is expected to take to execute the processing operation, based on past records of:
a first execution time measured when the processing operation was executed in the first information processing apparatus,
a second execution time measured when another processing operation different from the processing operation was executed in the first information processing apparatus, and
a third execution time measured when said another processing operation was executed in the second information processing apparatus.

6. The distributed processing method according to claim 1, further comprising calculating, by the processor, the threshold as a time that the second information processing apparatus is expected to take to execute the processing operation, based on past records of:
a first execution time measured when the processing operation was executed on a third information processing apparatus that is different from the first and second information processing apparatuses,
a second execution time measured when another processing operation different from the processing operation was executed on the third information processing apparatus, and
a third execution time measured when said another processing operation was executed in the second information processing apparatus.

7. An information processing apparatus capable of communicating with a remote information processing apparatus, the information processing apparatus comprising a processor configured to perform a procedure including:
requesting the remote information processing apparatus to execute a processing operation off-loaded from the first information processing apparatus, while the information processing apparatus is capable of executing the processing operation;
receiving an execution result of the processing operation from the remote information processing apparatus;
determining whether an amount of elapsed time since the requesting exceeds a threshold before an execution result of the processing operation is obtained from the remote information processing apparatus;
starting to locally execute the processing operation in the information processing apparatus when the amount of elapsed time is determined to have exceeded the threshold; and
using a local execution result of the processing operation executed in the information processing apparatus or the execution result obtained from the remote information processing apparatus, whichever comes earlier.

8. A computer-readable storage medium storing a program which causes a first computer to perform a procedure comprising:
requesting a second computer to execute a processing operation off-loaded from the first computer, while the first computer is capable of executing the processing operation;
determining whether an amount of elapsed time since the requesting exceeds a threshold before an execution result of the processing operation is obtained from the second computer;
starting to locally execute the processing operation in the first computer when the amount of elapsed time is determined to have exceeded the threshold; and
using a local execution result of the processing operation executed in the first computer or the execution result obtained from the second computer, whichever comes earlier.
